(19) United States
(12) Patent Application Publication
(10) Pub. No.: US 2024/0133813 A1
(43) Pub. Date: Apr. 25, 2024

(54) MULTI-MOLECULAR HYPERSPECTRAL PRM-SRS IMAGING

(71) Applicant: The Regents of the University of California, Oakland, CA (US)

(72) Inventors: Lingyan Shi, La Jolla, CA (US); Wenxu Zhang, La Jolla, CA (US)

(21) Appl. No.: 18/484,984

(22) Filed: Oct. 11, 2023

Related U.S. Application Data
(60) Provisional application No. 63/379,210, filed on Oct. 12, 2022.

(51) Int. Cl. G01N 21/64

(52) U.S. Cl. CPC G01N 21/6486; G01N 21/6458; G01N 2021/6423

(57) ABSTRACT

Multi-molecular hyperspectral PRM-SRS imaging technologies advantageously provide faster data processing and direct user-defined visualization with enhanced chemical specificity for distinguishing clinically relevant lipid subtypes in different organs and species. PRM-SMS may include quantifying the spectral similarity between an image pixel spectrum and a known reference spectrum.

### CROSS-REFERENCE TO RELATED APPLICATIONS

This application claims priority to U.S. Provisional Application No. 63/379,210 filed on Oct. 12, 2022, the entire contents of which are incorporated by reference.

### TECHNICAL FIELD

The present invention relates to multi-molecular hyperspectral PRM-SRS imaging technologies.

### BACKGROUND

Current lipidomic technologies, such as shotgun lipidomics, can quickly detect hundreds of lipids from small samples. Albeit highly sensitive, such methods rely on mass spectrometry (MS), nuclear magnetic resonance (NMR), or other techniques that destruct cells and tissues¹⁻⁴. Conventional matrix-assisted laser desorption/ionization (MALDI)-MS imaging enables label-free lipid imaging but it has a lateral resolution on the order of cell diameters (˜10 μm) and destroys the sample during the imaging process. In addition, 3D MALDI imaging relies on serial sections of the sample, and the lipid species that are resolvable are limited to those with the highest ion yields. Other optical techniques have been developed to non-destructively visualize spatial distributions of lipid pools⁵ as well as metabolic flux⁶ at the subcellular resolution, but they rely on markers, such as fluorescently labeled antibodies and transfected biosensors, which may alter the native distribution of lipids in cells or tissues. It is difficult to use labeled optical imaging to differentiate diverse molecular species simultaneously, since the diversity of lipid species far exceeds the specificity and availability of optical tags and dyes. Therefore, label-free optical imaging is instrumental. Stimulated Raman scattering (SRS) microscopy has demonstrated advantages of non-destructive 3D imaging with subcellular resolution in a label-free manner^{7,8}. Recent work has even demonstrated quantitative mass concentration measurements of lipids, proteins, and water⁹. For label-free SRS imaging microscopy, multiple subcellular organelles can be the chemical specificity is achieved through hyperspectral imaging (HSI) or training of a deep learning model¹⁰. Lock-in free multiplex SRS imaging can rapidly extract hundreds of morphological or metabolic features in situ to understand lipid metabolism in cancer cells¹¹. Despite these advancements, there has been no report on distinguishing multiple lipid subtypes in cells and tissue samples by using nondestructive label-free optical imaging methods.

In addition to imaging technologies, post-processing methods/algorithms also contribute to producing high resolution and high-quality images. Recent work on Raman HSI analysis using multivariate curve resolution alternating least squares (MCR-ALS) algorithm has demonstrated effective unmixing of chemical species without disturbing the native distribution of biomolecules¹². However, a higher spectral resolution may entail prohibitively long imaging time. In addition, unmixing lipid species using unsupervised methods can be computationally expensive and lack the ability to directly identify a chemical species without manual association posteriori. For example, the MCR-ALS approach converts a complex spectrum to a linear combination of component spectra, but it can take 30 minutes to process a 512×512 pixel hyperspectral image and presupposes the number of chemical species in a sample. The result displays a pixel's identity by its relative proportional composition of reference species. However, this is rarely feasible in a complex biological sample. Singular Value Decomposition (SVD) can estimate the number of components, however analytical results may be sensitive to slight deviations from the exact number of components. Clustering and segmentation of image pixels may be informed by MCR-ALS, but the precise molecular identities of the highlighted pixels may still be unknown, as there is no guarantee that the unmixed components correspond to a specific molecular type.

### SUMMARY

Disclosed herein are multi-molecular hyperspectral Penalized Reference Matching algorithm with Stimulated Raman Scattering (PRM-SRS) imaging technologies. PRM-SRS can advantageously provide faster data processing and direct user-defined visualization with enhanced chemical specificity for distinguishing clinically relevant lipid subtypes in different organs and species.

In embodiments, the disclosure provides a method of spectral angle mapping, where the method includes quantifying the spectral similarity between an image pixel spectrum and a known reference spectrum. In some embodiments, quantifying the spectral similarity between an image pixel spectrum and a known reference spectrum includes preprocessing an image to determine the image pixel spectrum, interpolating pixel intensities of the image pixel spectrum such that all the image pixel spectra have the same resolution, determining a similarity score between the image pixel spectra and the reference spectra, and proportionally reducing the similarity score with the positional discrepancy to the best spectral match. Reducing the similarity score can be effective to decrease the rate of false positive similarity scores. In some embodiments, the spectral angle mapping is effective to characterize lipid subtypes in human tissue. Characterizing lipid subtypes in human tissue can be effective for identifying tissue abnormalities. In some embodiments, the spectral angle mapping is effective to detect small and large molecules, such as lipids, proteins, DNA, RNA, carbohydrates, sugars, ions, and/or mineral molecules. In some embodiments, the spectral angle mapping is effective to qualify and/or verify a concentration of a chemical compound in a high throughput product. In some embodiments, the spectral angle mapping is effective to classify a material defect.

### BRIEF DESCRIPTION OF THE DRAWINGS

FIGS. 1A-1F. General Reference Matching Method. (FIG. 1A) A reference spectrum of a lipid subtype standard is acquired by spontaneous Raman spectroscopy and (FIG. 1B) preprocessed remove background and normalize. (FIGS. 1C-1D) A sample is imaged using SRS to generate a HSI. (FIG. 1E) Each pixel of the HSI is a vector of intensity values that represent the Raman spectrum at that pixel. (FIG. 1F) Similarity scores are calculated between each pixel and the reference spectra.

FIGS. 2A-2F. Penalized Reference Matching Method. (FIG. 2A) A lipid reference spectrum (blue greyscales) was collected by spontaneous Raman spectroscopy, and an SRS HSI pixel spectrum (orange greyscales) was compared with the reference spectrum. (FIG. 2B) Demonstration of shifts in pixel's spectrum: 7.13 cm⁻¹ left shift and 21.39 cm⁻¹ right shift. These positional offsets decrease the final similarity score because the penalty term scales exponentially to the positional offset. (FIG. 2C) Matching scores are retrieved by dot product between the reference signal and SRS pixel's signal. Then the penalty—estimated with a quadratic function—is subtracted from each matching score. When the shift wavenumber is high, a high penalty will be given. The highest value in this score curve will be used as the similarity score between this pixel spectrum and that of the pure reference standard. (FIG. 2D) Image illustrating the distribution of cardiolipin in a murine dentate gyrus sample with a penalty coefficient of α=1×10⁴. (FIG. 2E) Image with the penalty coefficient α=4×10⁴. The full range of the cardiolipin distribution was not clearly shown due to over-penalization. (FIG. 2F) An over-saturated image with the penalty coefficient α=0.25×10⁻⁴. Almost all pixels have a high similarity score due to under-penalization.

FIGS. 3A-3F. Spectral PRM cross correlation in the fingerprint and CH stretching regions. (FIGS. 3A-3B) Raman signals from fat body tissues of young and old Drosophila in the fingerprint and CH regions. (FIGS. 3C-3D) Raman signals of the cholesterol reference standard in fingerprint and CH stretching regions, respectively. (FIG. 3E) Fingerprint region similarity scores of young and old Drosophila fat body samples to the cholesterol reference standard. p=4.85×10⁻⁴ by Wilcoxon rank sum test. (FIG. 3F) CH-stretch similarity scores of young and old Drosophila fat body samples to the cholesterol reference standard. p=0.0037 by Wilcoxon rank sum test. **p<0.01, ***p<0.001.

FIGS. 4A-4D. PRM-SRS and fluorescence staining show similar results. (FIGS. 4A-4B) Comparison of PRM-SRS and fluorescence staining in control cells expressing shCtr (Ctr) (FIG. 4A) and PGS1 knockdown (shPGS1) (FIG. 4B) HEK293 cells. Panels on the left, two photon fluorescence microscopy (TPF) images following nonyl acridine orange (NAO)-labeling of CL. Panels on the right, label-free SRS hyperspectral images of CL at the CH-stretching region. Quantitative analyses of NAO staining signal intensity (FIG. 4C) and PRM-SRS imaging signal intensity (FIG. 4D) of CL in control and shPGS1 cells. Significantly decreased signals in shPGS1 cells were detected by both TPF and PRM-SRS microscopy. Data are presented as mean±SEM and analyzed by One-way ANOVA with Bonferroni post hoc test; ****p<0.0001. Scale bar, 10 μm.

FIGS. 5A-5D. Label-free hyperspectral detection of different lipid subtypes in situ using PRM-SRS. (FIGS. 5A-5B) SRS image of a human kidney tissue section at 2850 cm⁻¹. Panel B shows the enlarged image of the boxed area in panel A. Hollow arrowheads, intracellular lipid droplets in tubules. Solid arrowheads, eosinophilic bodies. Circles, lipid droplets sequestered by podocytes in the glomerulus. Scale bar, 200 μm. (FIG. 5C) PRM-SRS spectra (top panels) and images (bottom panels) of different lipid subtypes of interest show the distribution of the similarity scores, each with the same contrast levels. Resulting similarity score images were background subtracted to improve the contrast. Spectra of the top 10% of similarity score pixels overlaid on the reference spectrum for each lipid subtype show consistent matches. (FIG. 5D) Schematic diagram of glomerular pathologies associated with dyslipidemia in kidney diseases.⁴⁹ Scale bar, 200 μm.

FIGS. 6A-6G. PRM-SRS imaging of Drosophila fat body cells detects different lipid subtypes and their subcellular distribution. (FIG. 6A) Maximum intensity projection (MIP) of the PRM-SRS hyperspectral image of total lipids reveals lipid droplets. (FIG. 6B) PRM-SRS detected TAG in lipid droplet cores. (FIG. 6C) Lysosome-like structures detected by PRM-SRS using reference spectra measured from lysosome-like structures in drosophila fatbody. (FIG. 6D) PE:TAG ratiometric images show that the interstitium between lipid droplet cores and lysosome-like structures has higher relative levels of PE. (FIG. 6E) PRM-SRS subtype images are merged to detect co-localization of different lipid subtypes. (FIG. 6F) Similarity scores from areas marked by red circles 1 and 2 in the lower part of FIG. 6D highlight the necessity of evaluating relative concentrations as opposed to absolute concentrations. (FIG. 6G) Intensity profiles along the dotted white lines in FIG. 6A and FIG. 6E, upper and lower panels respectively, show how signal intensity varies with spectral shape, rather than concentration in a PRM-SRS image. Scale bar is 20 μm.

FIGS. 7A-7L. PRM-SRS imaging of mouse hippocampal samples. (FIGS. 7A-7J) PRM-SRS hyperspectral detection of cholesterol, PC, and PE in hippocampus samples from young and old mice. Overall intensity of detected lipid subtypes shows distinct patterns, with old brains showing higher cholesterol to PE ratio, but relatively consistent levels of PE and PC. (FIG. 7D, FIG. 71) Ratiometric images of cholesterol to PE shows more nuclei with higher cholesterol/PE ratio in the old brains. Selected nuclei are marked by red circles (FIG. 7E, FIG. 7J) Ratiometric images of PC relative to PE show higher PC/PE ratio in granule cell nuclei of both young and old brains, but the spatial distribution of the ratio is more heterogeneous in young samples (see nuclei marked by purple arrows). (FIG. 7K, FIG. 7L) Mass spectrometry (FIG. 7K) shows results consistent with that obtained by ratiometric PRM-SRS imaging (FIG. 7L). Summed concentrations of lipids were simplex normalized and displayed in the ratio form. Error bars represent standard deviation. (FIG. 7L) Ratiometric image intensities, corresponding to the ratio of PRM similarity scores of lipid subtypes, are plotted. Error bars represent standard deviation. Scale bar, 20 μm.

FIGS. 8A-8F. Hyperspectral SRS imaging detection of cardiolipin and sphingosine signals in a human brain tissue section. (FIG. 8A) Sphingosine signals in the brain tissue; (FIG. 8B) CL in the same region of interest; (FIG. 8C) merged image of CL and Sphingosine; (FIG. 8D) Zoomed-in image of a single brain cell with CL and Sphingosine signals. (FIG. 8E) Ratiometric image of CL to Sphingosine signals. (FIG. 8F) Intensity profile of (FIG. 8E) along the indicated white dashed line. Scale bar, 10 μm.

FIGS. 9A-9B. CH stretching region spectrum and t-SNE plot of their fitting parameters. (FIG. 9A) Spontaneous Raman spectrum of PE lipid. With four Gaussian peaks centered on four different wavenumbers, spectral shape was fitted. (FIG. 9B) To show the capability of lipid subtype separation based on CH stretching region spectra, t-SNE plot of 38 lipid subtypes is presented. The plot shows enough distances between each lipid subtype.

FIGS. 10A-10F. Relative concentrations and similarity scores in samples containing mixtures of different lipid subtypes. (FIGS. 10A-10B) Spontaneous Raman spectra and corresponding similarity scores of mixtures of ceramide and TAG (C2-C10) (Sigma 17810-1AMP-S) at the indicated ratios. (FIGS. 10C-10D) The experiment repeated with the addition of equal volume of methanol-washed tissue lysates, showing a deterioration of similarity scores but a preservation of trend. (FIG. 10E) Experiments with three-lipid mixes (CER, TAG and cardiolipin) at various ratios were also conducted. Raw similarity scores (middle panel) and relative similarity scores normalized to the first group with equal ratios (right panel) are shown. (FIG. 10F) Plotting both raw and normalized (relative) similarity scores using each component as an axis, show similar patterns to the actual concentrations. All spectra were acquired on the same instrument (HORIBA XploRa plus). The highest similarity scores were achieved with a spectral shift of 0.

FIGS. 11A-11E. Comparison of PRM and pseudo-inverse matrix multiplication. (FIG. 11A) The data shown in FIGS. 9A-9B were analyzed using pseudo-inverse (PINV) matrix multiplication and the resulting coefficients were plotted in blue greyscales. The similarity scores obtain by PRM were in orange. Pseudo-Inverse matrix coefficients have a linear relationship with relative ratios of the components but have negative coefficients and a theoretically unbounded range. (FIG. 11B) The data shown in FIGS. 9C-9D were analyzed using PINV and the resulting coefficients were plotted (blue) against those using PRM (orange). PINV shows a better linear relationship than PRM similarity scores but retains the negative and unbounded range. (FIG. 11C) Comparison of computation time for PRM and PINV with single processing unit and no spectral shifts shows that PINV takes much longer time to compute compared with PRM. PINV is also a one-liner that is difficult to split to parallel processing units, and does not allow for the input matrix to be split into more manageable sizes because the rank sums would not be equal. (FIG. 11D) The data shown in FIGS. 9E-9F were re-analyzed using PINV, and the linear relationship is also observed, but additional rescaling steps removing negative values were required to obtain concentration-correlated results. (FIG. 11E) The three-lipid mixtures from FIG. 11D are plotted in 3D, showing that both PRM and PINV can obtain results similar to the ground truth.

FIGS. 12A-12F. PRM is more robust than PINV across spectral datasets. (FIG. 12A) Computation time is recorded for SAM via inner product, PINV using the stock MATLAB function as of R2022b, and PINV via manual inverse matrix multiplication using the same spectral dataset for each method. The dataset consists of random integer spectra with 1000 wavenumbers each. The number of spectra computed (x-axis) in the dataset are typical of HSI sizes such as 512×512 pixel images. (FIG. 12B) The resulting similarity scores from SAM and coefficients from PINV are plotted against each other for the random dataset. The results for PINV whether via the stock MATLAB function or via manual inverse matrix multiplication are identical, so only one set is plotted. The outlying point is the result of the first spectrum in the dataset being compared to itself. Notice how the SAM result of this exact match is 1, which is intuitive, while the majority of computation results are centered at 0 for the PINV, which is also intuitive. Therefore there is a tradeoff between whether the perfect match or random match should be intuitive. Since the Raman spectra of biological samples are not entirely random, but share general similarities, SAM scores are preferred due to their intuitive range. (FIG. 12C) 5 dummy spectra are created and both similarity scores and PINV scores are plotted. Then one of the 5 dummy spectra are removed and both sets of scores are re-plotted. The similarity scores via SAM of all the other spectra are unchanged, which should be expected. However, the PINV coefficients of the other spectra did change. This is critical because HSI of various sizes and pixel densities may yield different PINV coefficients even though the spectra of the analyte is exactly the same. (FIG. 12D) Adjustment one wavenumber of a spectrum only affects the similarity score of that spectrum, which should be expected. However, adjusting just one wavenumber of one spectrum in the dataset affects all other PINV coefficients in that dataset.

FIGS. 13A-13B. 200 proof Ethanol SRS HSI spectra. (FIG. 13A) All pixel spectra in a 64×64 test SRS HSI of pure ethanol shows very little pixel-wise “noise”. All pixels in the image have a relatively consistent spectral profile, as expected. (FIG. 13B) This homogeneity is translated into similarity scores, and confirms that the image quality of the SRS HSI is sufficient, considering the vast majority of pixels all have nearly perfect similarity scores with respect to a spontaneous Raman spectrum of the ethanol standard.

FIGS. 14A-14C. Immunofluorescence microscopy confirmed reduced PGS1 protein expression in shPGS1 cells. (FIG. 14A) Immunofluorescence staining of stable shPGS1 cells using the specific PGS1 antibody. (FIG. 14B) Quantification of immunofluorescence signal intensity in images shown in panel A. Compared to the control group, the PGS1 protein level was significantly reduced by shPGS1 following induction with tetracycline (Tet). (FIG. 14C) TPF (following NAO staining), SRS, and PRM-SRS images from FIG. 4 demonstrate that the similarity score-based PRM-SRS image for CL distribution is similar to that shown by NAO staining (TPF) but distinct from single Raman shift SRS images. Scale bar: 10 μm.

FIGS. 15A-15B. Similarity indices and normalized mean squared errors between NAO stained cardiolipin image and PRM-SRS detected lipid subtype images (cardiolipin, PE, cholesterol, and sphingosine). In the two samples (a: Control, b: ShPGS1), the similarity index of cardiolipin was higher than the indices of other lipid subtypes. Normalized mean squared error of cardiolipin image was lower than other lipid subtypes. Due to the low intensity in ShPGS1 sample, similarity index was lower than control, and normalized mean squared error was higher than control.

FIGS. 16A-16B. HSI and Ratiometric image of Free cholesterol to Esterified Cholesterol PRM-SRS images from FIG. 5. (FIG. 16A) Hyperspectral image frames of the human kidney tissue section from 2750 cm−1 to 3050 cm−1. (FIG. 16B) Cholesterol:cholesterol ester ratiometric image. Ratio values are based on the similarity scores from the PRM-SRS images. Higher similarity scores for free cholesterol occur intracellularly in tubules and glomerular epithelial cells that line the arteriole and capillaries of the mesangium, as well as the larger deposits indicated by solid arrows in FIG. 5B.

FIG. 17. SRH (virtual H&E) image of the human brain temporal cortex sample. Scale bar: 10 μm.

### DETAILED DESCRIPTION

All publications, patents, and patent applications mentioned in this specification are herein incorporated by reference to the same extent as if each individual publication, patent, or patent application was specifically and individually indicated to be incorporated by reference.

These and other embodiments and combinations of the embodiments will be apparent to one of ordinary skill in the art upon a review of the detailed description herein.

Unless defined otherwise, all terms of art, notations and other technical and scientific terms or terminology used herein are intended to have the same meaning as is commonly understood by one of ordinary skill in the art to which the claimed subject matter pertains. In some embodiments, terms with commonly understood meanings are defined herein for clarity and/or for ready reference, and the inclusion of such definitions herein should not necessarily be construed to represent a substantial difference over what is generally understood in the art.

As used herein, the terms “comprises,” “comprising,” “includes,” “including,” “has,” “having,” “contains”, “containing,” “characterized by,” or any other variation thereof, are intended to encompass a non-exclusive inclusion, subject to any limitation explicitly indicated otherwise, of the recited components. For example, a composition, and/or a method that “comprises” a list of elements (e.g., components, features, or steps) is not necessarily limited to only those elements (or components or steps), but may include other elements (or components or steps) not expressly listed or inherent to the composition and/or method. Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present invention. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the transitional phrases “consists of” and “consisting of” exclude any element, step, or component not specified. For example, “consists of” or “consisting of” used in a claim would limit the claim to the components, materials or steps specifically recited in the claim. When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”. It is understood that aspects and embodiments of the invention described herein include “consisting” and/or “consisting essentially of” aspects and embodiments.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “and/or” when used in a list of two or more items, means that any one of the listed items can be employed by itself or in combination with any one or more of the listed items. For example, the expression “A and/or B” is intended to mean either or both of A and B, i.e. A alone, B alone or A and B in combination. The expression “A, B and/or C” is intended to mean A alone, B alone, C alone, A and B in combination, A and C in combination, B and C in combination or A, B, and C in combination.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The terms “quantifying” “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

The terms “subject,” “patient” and “individual” are used interchangeably herein to refer to a vertebrate, preferably a mammal, more preferably a human. Tissues, cells, and their progeny of a biological entity obtained in vivo or cultured in vitro are also encompassed. A “subject,” “patient” or “individual” as used herein, includes any animal that exhibits pain that can be treated with the vectors, compositions, and methods contemplated herein. Suitable subjects (e.g., patients) include laboratory animals (such as mouse, rat, rabbit, or guinea pig), farm animals, and domestic animals or pets (such as a cat or dog). Non-human primates and, preferably, human patients, are included.

In embodiments, the disclosure provide methods of treatment of a disease or condition comprising administering to a subject in need thereof an effective amount of a treatment for the disease or condition resolved using the subject tissue imaging techniques described herein.

As used herein, the term “amount” refers to “an amount effective” or “an effective amount” of a cell to achieve a beneficial or desired prophylactic or therapeutic result, including clinical results. As used herein, “therapeutically effective amount” refers to an amount of a pharmaceutically active compound(s) that is sufficient to treat or ameliorate, or in some manner reduce the symptoms associated with diseases and medical conditions. When used with reference to a method, the method is sufficiently effective to treat or ameliorate, or in some manner reduce the symptoms associated with diseases or conditions. For example, an effective amount in reference to diseases is that amount which is sufficient to block or prevent onset; or if disease pathology has begun, to palliate, ameliorate, stabilize, reverse or slow progression of the disease, or otherwise reduce pathological consequences of the disease. In any case, an effective amount may be given in single or divided doses.

As used herein, the terms “treat,” “treatment,” or “treating” embraces at least an amelioration of the symptoms associated with diseases in the patient, where amelioration is used in a broad sense to refer to at least a reduction in the magnitude of a parameter, e.g. a symptom associated with the disease or condition being treated. As such, “treatment” also includes situations where the disease, disorder, or pathological condition, or at least symptoms associated therewith, are completely inhibited (e.g. prevented from happening) or stopped (e.g. terminated) such that the patient no longer suffers from the condition, or at least the symptoms that characterize the condition.

As used herein, and unless otherwise specified, the terms “prevent,” “preventing” and “prevention” refer to the prevention of the onset, recurrence or spread of a disease or disorder, or of one or more symptoms thereof. In certain embodiments, the terms refer to the treatment with or administration of a compound or dosage form provided herein, with or without one or more other additional active agent(s), prior to the onset of symptoms, particularly to subjects at risk of disease or disorders provided herein. The terms encompass the inhibition or reduction of a symptom of the particular disease. In certain embodiments, subjects with familial history of a disease are potential candidates for preventive regimens. In certain embodiments, subjects who have a history of recurring symptoms are also potential candidates for prevention. In this regard, the term “prevention” may be interchangeably used with the term “prophylactic treatment.”

As used herein, and unless otherwise specified, a “prophylactically effective amount” of a compound is an amount sufficient to prevent a disease or disorder, or prevent its recurrence. A prophylactically effective amount of a compound means an amount of therapeutic agent, alone or in combination with one or more other agent(s), which provides a prophylactic benefit in the prevention of the disease. The term “prophylactically effective amount” can encompass an amount that improves overall prophylaxis or enhances the prophylactic efficacy of a prophylactic agent.

As used herein, and unless otherwise specified, a “prophylactically effective amount” of a compound is an amount sufficient to prevent a disease or disorder, or prevent its recurrence. A prophylactically effective amount of a compound means an amount of therapeutic agent, alone or in combination with one or more other agent(s), which provides a prophylactic benefit in the prevention of the disease. The term “prophylactically effective amount” can encompass an amount that improves overall prophylaxis or enhances the prophylactic efficacy of another prophylactic agent.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as, but not limited to, source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, solid state devices (SSDs), and the like. The one or more memory devices (not shown) may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Disclosed herein are multi-molecular hyperspectral PRM-SRS imaging technologies. Lipids may play crucial roles in many biological processes under physiological and pathological conditions. Mapping spatial distribution and examining metabolic dynamics of different lipids in cells and tissues are critical for understanding aging and diseases. Commonly used imaging methods, including mass spectrometry-based technologies or labeled imaging techniques, tend to disrupt the native environment of cells/tissues and have limited spatial or spectral resolution, while traditional optical imaging techniques still lack the capacity to distinguish chemical differences between lipid subtypes.

To overcome these limitations, the disclosure provides a new hyperspectral imaging platform that integrates a Penalized Reference Matching algorithm with Stimulated Raman Scattering (PRM-SRS) microscopy. This new approach enables direct visualization and identification of multiple lipid species in cells and tissues in situ with high chemical specificity and subcellular resolution. High density lipoprotein (HDL) particles containing non-esterified cholesterol were observed in the kidney, indicating that these pools of cholesterol are either ectopic deposits or are yet to be enriched. For example, a higher cholesterol to phosphatidylethanolamine (PE) ratio was detected inside the granule cells of hippocampal samples in old mice, suggesting altered lipid synthesis and metabolism in aging brains. PRM-SRS imaging also revealed subcellular distributions of sphingosine and cardiolipin in the human brain samples. Compared with other techniques, PRM-SRS demonstrates unique advantages, including direct user-defined visualization with enhanced chemical specificity and efficient data processing in distinguishing multiple lipid subtypes in different organs and species. The method disclosed herein therefore has broad applications in multiplexed cell and tissue imaging.

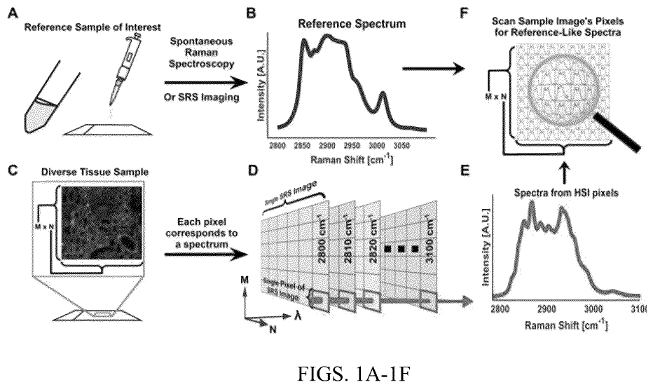

Spectral reference matching approaches, also known as spectral angle mapping, have been widely applied to Raman spectral analyses by quantifying the spectral similarity between an image pixel spectrum and a known reference spectrum¹³. FIGS. 1A-1F show the general process of reference matching approach⁴ applied to hyperspectral imaging. First, spectra of the target analytes (the reference standards of interest) are acquired using spontaneous Raman spectroscopy (FIG. 1A) and preprocessed for background removal and normalization (FIG. 1B). Hyperspectral Raman microscopy imaging is next performed on the sample of interest, in which each pixel contains specific spectral information (FIGS. 1C-1D). Then each pixel's spectrum is preprocessed in the same way as the reference spectrum (FIG. 1E) and is analyzed with respect to the reference spectrum by calculating the cosine similarity score (FIG. 1F).

However, the general spectral reference matching approach has low specificity and the high incidence of false positives makes it difficult to implement in vibrational spectroscopy. This is because the peak position and intensity differences of spectra generated by various equipment can produce uncertainty that overshadows the subtle differences between lipid subtypes. To enhance the specificity for accurately distinguishing lipid species, a Penalized Reference Matching (PRM) algorithm was developed and applied to SRS (PRM-SRS) microscopy, and accumulated a library of 38 biomolecules for potential detection. This method is efficient and can process a 512 pixels×512 pixels×76 hyperspectral image stack within one minute. This method utilizes dominant components to illustrate the application of PRM-SRS in analyzing different lipid subtypes. This new method will therefore provide quantitative and qualitative insights into different roles of lipid species in multiple biological processes and can augment other unmixing techniques as well.

A PRM algorithm that can efficiently unmix and distinguish a variety of lipid subtypes from single SRS HSI stacks was developed. Compared with fluorescence imaging, our PRM-SRS platform shows advantages of multiplexed lipid subtype visualization from single label-free HSI sets. This also represents a significant expansion in applications compared with traditional SRS imaging, which often relies on detecting total lipids in the CH-stretching mode at 2850 cm⁻¹.

With an improved contrast, PRM-SRS imaging enables identification of different lipid subtypes. The spectra of lipid subtype-standards collected from spontaneous Raman scattering microscopy can be utilized in analyzing HSI data collected from SRS microscopy. PRM-SRS can generate both co-localization and ratiometric data of individual lipid subtypes simultaneously by mapping their spatial distributions and quantifying their relative concentrations. A Raman spectra library was established with 38 lipid subtypes standards and demonstrated the simultaneous detection of a few selected lipid subtypes by PRM-SRS in cells and tissues. Analyses of human kidney tissue samples indicate that PRM-SRS can be used to identify different lipid subtypes associated with renal diseases, suggesting potential application of PRM-SRS in diagnosis and prognosis of these diseases, including those associated with dyslipidemia. Such label-free methods may be instrumental in early detection of kidney diseases by detecting and measuring relative levels of different lipid biomarkers without the need to stain biopsied samples or perform destructive imaging, especially on limited clinical samples. Analyses of Drosophila fat body samples show that PRM-SRS can be used effectively in mapping spatial distributions of lipid subtypes at the subcellular scale. These results highlight the ability of PRM-SRS to selectively visualize multiple lipid subtypes in a single image with the ease and freedom akin to individual subtype-labeled imaging without the need to actually label them. Analyses of mouse and human brain tissues demonstrate the importance of measuring relative lipid concentrations through ratiometric imaging, which reveals regionally different concentrations of lipid subtypes that may not be readily apparent in single-channel images. Although lipid subtypes are not measured in absolute concentrations, their relative levels are consistent with results from other modalities such as mass spectrometry (MS).

The brain is a lipid-rich organ. Lipid subtypes such as cholesterol and sphingolipids are important components of the brain. Alteration in lipid subcellular distribution and metabolism impact on brain cell function ad have been associated with neurological diseases. These analyses of mouse and human brain tissues illustrate the capability of PRM-SRS in quantitatively mapping and analyzing distribution of different lipid subtypes within single cells. These analyses confirm the cross-applicability of the fingerprint and CH-stretching spectral regions for quantitative analyses. Further, PRM-SRS imaging shows that sphingosine, a catabolic product of sphingomyelin, has a predominantly nuclear localization. Nuclear sphingomyelinase and sphingosine kinases regulate the release of ceramides and sphingosine, as well as the conversion of sphinogosine to sphingosine-1-phosphate. These processes regulate cell proliferation and cell death³⁶. Sphinogosine kinases may shift from a cytosolic to a nuclear localization in the brain samples from Alzheimer's disease patients³⁷. Development of new technologies in imaging distinct lipid subtypes and their metabolism will enhance the ability to investigate molecular mechanisms underlying different brain disorders.

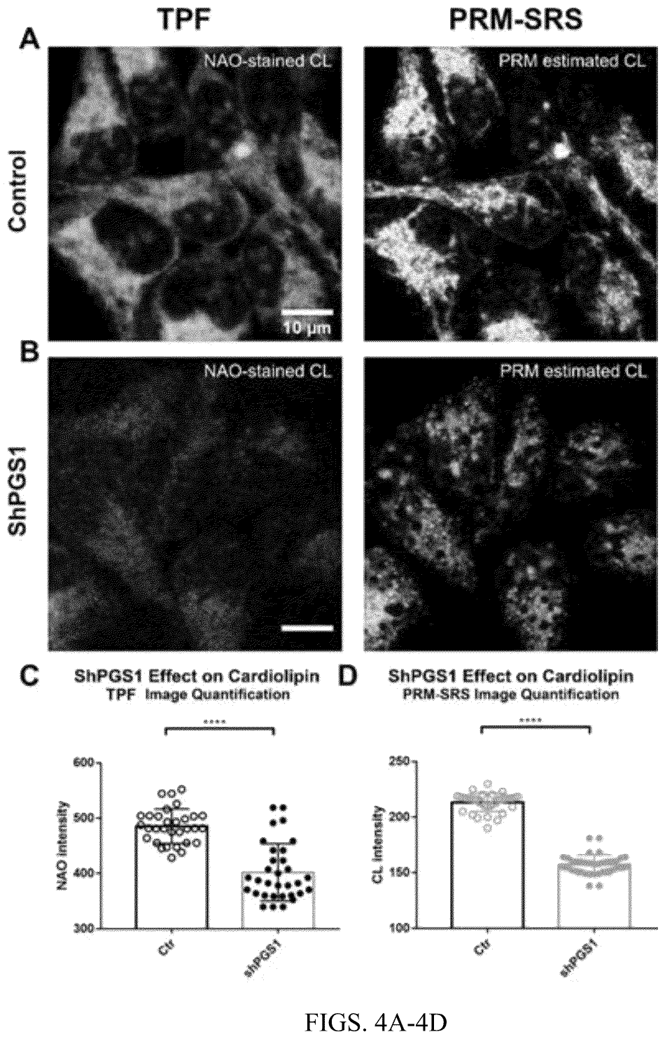

As shown in FIGS. 4A-4D, PRM-SRS has sufficient capability to provide quantitative information on lipid subtype distribution. Theoretically, the similarity scores and concentrations of dominant molecules have a linear relationship in a certain dynamic concentration range. However, spectral shifts caused by multiple interfering factors (such as changes in chemical environment or instrumentation) may distort the relationship between the similarity scores and concentrations. Since the spectral shifts can be caused by multiple factors, it is difficult to define an exact function of a spectral shift. Nevertheless, such spectral shifts can be corrected by using the penalized regression analysis. In brief, the penalty term helps us calculate the similarity score to more precisely describe the linear relationship with concentration.

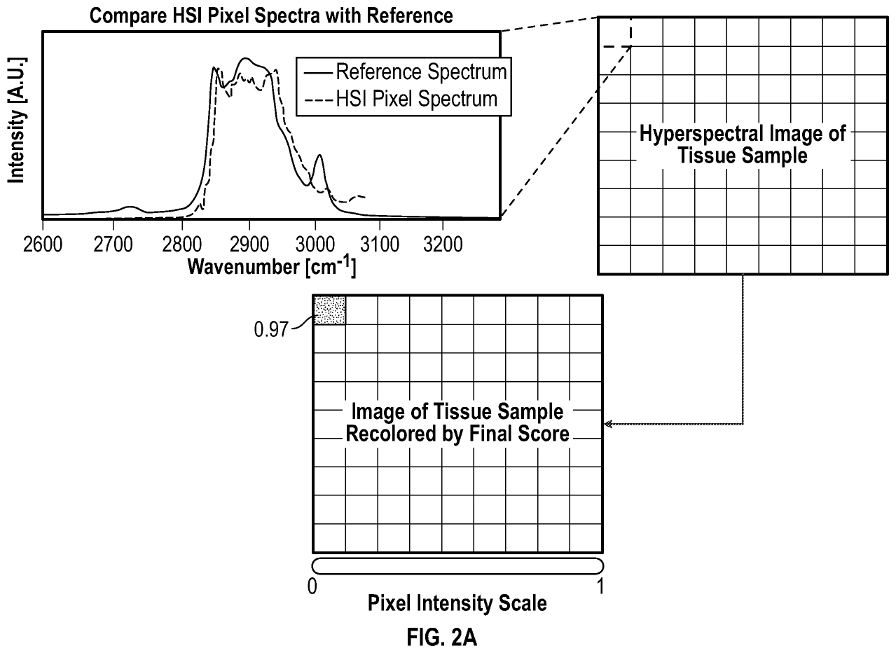

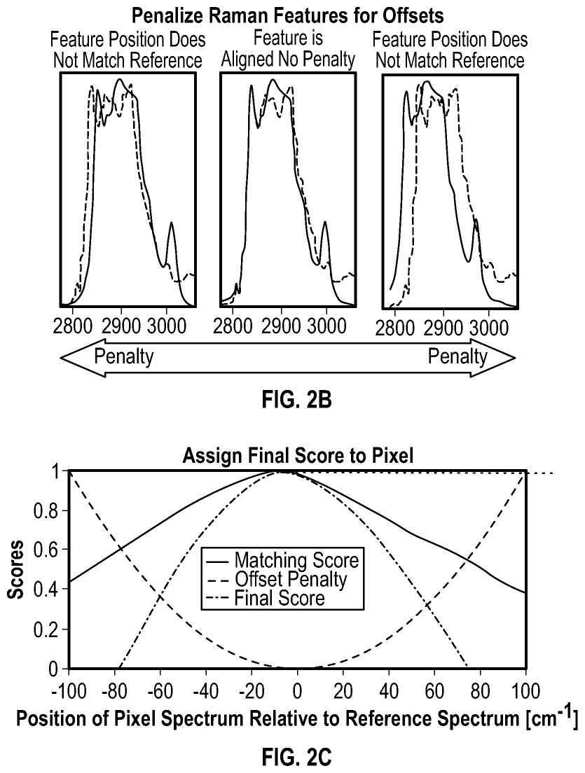

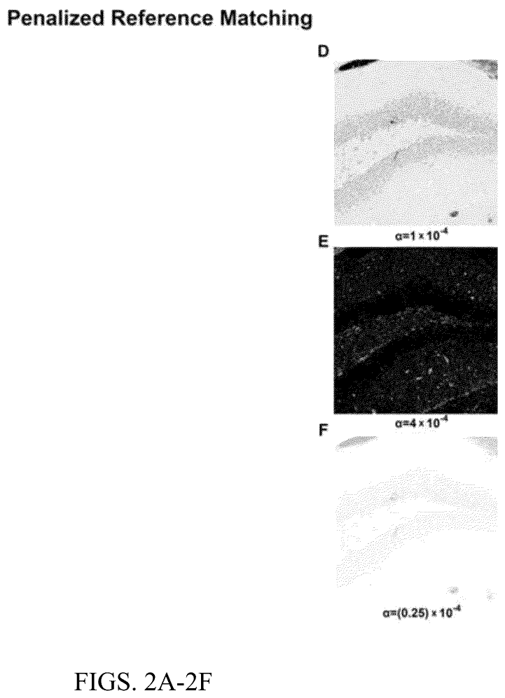

Depending on the equipment used and the samples of interest, careful tuning of the penalty term in the PRM algorithm is necessary. At present, the PRM-SRS platform should be used in a well-controlled environment to limit external chemometric dimensions. In this way, spectral signals are more likely from molecular subtypes in the samples, rather than from noises. Since Raman peak intensities are multiplexed in the sense that a specific peak shape may be influenced by multiple molecules, it is critical that molecular makeup is as consistent as possible when using PRM-SRS to determine relative concentrations of different molecular subtypes. In the current PRM platform, users should determine the optimal penalty coefficient experimentally to avoid artificial increases or decreases of similarity scores. An extremely low penalty coefficient would allow the comparison between the reference spectra and pixel spectra to occur at any offset, which may inflate the overall similarity score. For example, ceramide has a notably high peak at 2880 cm⁻¹, while pixel spectra typically have the most prominent peak at the 2940 cm⁻¹ area. Allowing spectral offsets without penalty may result in a high similarity score because the ceramide reference could yield a high similarity score with the pixels with a sharp 2940 cm⁻¹ peak. On the other hand, an extremely high penalty coefficient would be akin to not allowing spectral offsets during comparison at all, which would be similar to traditional reference matching. This is disadvantageous because spectra acquired with different equipment may not be exactly calibrated on the same x axis, which could artificially decrease the similarity scores. While these cases do not occur often, the greatest similarity score does not occur at very small offsets. FIGS. 2D-2F shows PRM-SRS images with different penalty coefficients. Although the PRM-SRS pipeline can be further enhanced by including more comprehensive reference standards and further increasing analysis speed, this platform is robust for analyzing different lipid subtypes. Reference matching could also be a useful tool to detect the presence of representative mixtures of compounds, not simply individual molecules.

The main advantages of PRM-SRS include multiplexed molecular subtype visualization, positive values and fast speed of similarity score calculation. Similarity scores are always positive values since Raman intensities cannot be negative. On the other hand, pseudo-inverse matrix (PINV) coefficients can be negative, which will make it difficult to normalize the output. The similarity score calculation is faster than other methods, such as the pseudo-inverse matrix. PRM and PINV show similar results in correlation with relative concentrations. However, PINV-based calculation time increases exponentially with the number of spectra in the original matrix and image size. When analyzing 1024×1024 hyperspectral images using PINV, there are millions of spectra in a single experiment. On the other hand, similarity score calculation using PRM-SRS is based on the inner-product, which is easily vectorized and split in a parallel pool. Considering the number of spectra in a single HSI stack, the calculation speed is an important factor as a practical analysis tool for image analysis. Although the PRM-SRS result cannot provide absolute concentrations as precisely calibrated linear unmixing methods, this approach clearly shows advantages over other methods.

PRM-SRS can also be used together with other chemometric methods, such as Gas Chromatography Mass Spectrometry (GC-MS), for cross validation, as the incidence of false positive may still be high. Finally, detection of the vast variety of lipid subtypes may require further improvement in unmixing methods and spectral resolution, as the lipid subtype reference library is expanded, and more lipid subtypes are further evaluated. With some adjustments, such as using different reference libraries, this PRM-SRS platform can be extended to analyzing other molecules, including proteins, nucleic acids, and even clinically relevant molecular complexes (such as protein aggregates or oligomers). Using heavy water (D₂O) probed SRS (DO-SRS), metabolic imaging can also distinguish de novo newly synthesized biomolecules, including lipids, proteins, and DNA³⁸⁻⁴⁰, from old existing biomolecules in cells and tissues at the subcellular resolution. This ever-expanding library of molecular subtype references may warrant broader spectral regions, including the fingerprint, CH-stretching, and O—H stretching regions to increase the chemometric dimensions. Due to the stronger signal in the CH-stretching region than the fingerprint region, the CH-stretching region was an area of focus when analyzing lipids. Integration of statistical denoising and regression methods will help increase the power of molecular subtype matching. Application of higher order signal manipulations such as digital derivatives and wavelet analyses, will enhance the ability to extract the most prominent as well as subtle but important features.

The new hyperspectral imaging platform—PRH-SRS—disclosed herein allows for the direct identification of multiple molecular species in situ with subcellular resolution and high chemical specificity by leveraging the cross-applicability of spectral reference libraries and HSI methods. This PRM-based method can be applied to various microscopy setups, such as SRS, FTIR, and spontaneous Raman scattering spectroscopy. Compared with existing HSI methods, PRM-SRS shows a much-enhanced speed and efficiency. With appropriate reference spectra established, PRM-SRS can be used to detect a wide range of different biomolecules. This new platform can also be applied to studying metabolism of diverse types of biomolecules in cell and tissue samples. For example, when combined with transciptomics analyses following up- or down-regulation of lipid metabolism genes, it will be highly useful for investigating metabolic changes under different pathophysiological conditions. With its easy implementation, PRM-SRS can be combined with high-throughput methods, such as microfluidic/nanofluidic devices and single-cell apparatuses, or with large-area HSI mapping methods. The application of deep learning algorithms such as DeepChem may further improve the speed in femtosecond SRS imaging¹⁰. PRM-SRS could benefit from additional improvements, such as distortion-free polygon scanning and spectral focusing, as well as from machine learning to enhance the SNR³⁷. Finally, PRM could easily augment other unmixing methods, including MCR-ALS by providing fast initial component spectra. Thus, PRM-SRS has great potentials in multiplex cell and tissue imaging with a broad spectrum of applications.

### EXAMPLES

### Sample Preparation

### HEK293 Cell Cultures

The parental HEK293 cell line was obtained from the American Type Culture Collection (ATCC). Cells were cultured in DMEM supplemented with 5% fetal bovine serum (FBS), 1% penicillin/streptomycin (Fisher Scientific, Waltham, MA).

The control shRNA construct was prepared according to known protocols³⁸. A shPGS1 construct was designed to express PGS1 by expressing shRNA against PGS1 (target sequence) in the plasmid vector Tet-pLKO-puro (Vector Builder Inc.) to specifically down-regulate expression of PGS1. The control and shPGS1 constructs were transfected into HEK293 cells using lipofectamine (Invitrogen). Following transfection, cells were selected using puromycin (1 μg/ml) and stably expressing cell clones were obtained. Control and shPGS1 cells were prepared for immunostaining, NAO staining or SRS imaging. Cells were passaged at 80% confluence and plated on #1 thickness laminin coated coverglasses (GG12-laminin, VWR). After allowing cells to adhere to the coverglasses for 2 hours, cells were fixed using 4% v/v PFA for 15 min and stained with 100 nM NAO in the dark for 30 min. Cells were SRS imaged transmissively through #1 thickness coverglass.

Immunofluorescence staining was performed following a known protocol³⁸ using a polyclonal rabbit anti-PGS1 (Sigma-Aldrich, Cat #AV48896) and secondary antibody conjugated with Alexa-488 (Abcam, Cat #ab150081).

### Human Kidney Tissue Preparation

De-identified human kidney tissue sections (30 μm) were prepared from 4% v/v PFA-fixed frozen biopsy samples using a Compresstome (VF-210-0Z, Precisionary). The kidney cortex was isolated for imaging. Samples were imaged between 1 mm thick glass slide and #1 thickness coverglass, submerged in 1×PBS.

### Human Brain Tissue Preparation

De-identified post-mortem autopsy human brain sections (6 μm) were prepared from formalin-fixed and paraffin-embedded cortex tissue of control subject without detectable neuropathology^{39,40}. The sections were then deparaffinized according to known protocols¹³. Subsequent SRS imaging was conducted with the tissue sections sandwiched in PBS between 1 mm thick glass slides and #1 thickness cover glass.

### Mouse Brain Samples

Young (3 months) and aged (18 months) mice were euthanized with 5% isoflurane, and then perfused with 4% paraformaldehyde. The brains were harvested and fixed in 4% paraformaldehyde at 4° C. for overnight. The fixed brains were washed with PBS and cut into 120-μm thickness slices with Vibratomes (Precisionary). The brain slices were placed in the center of a spacer and sandwiched between glass slides and coverslip for hyperspectral SRS imaging.

Drosophila Fat body Samples

Wild type (w¹¹¹⁸ stock #5905) were originally obtained from the Bloomington Stock Center and have been maintained in the lab for several generations. Fat bodies were dissected from day 7 adult flies and fixed in 4% PFA (in 1×PBS) for 15 min. Samples were imaged immediately using SRS microscopy for hyperspectral imaging.

### Spontaneous Raman Spectroscopy

Spontaneous Raman scattering spectra were obtained by a confocal Raman microscope (XploRA PLUS, Horiba) equipped with a 532 nm diode laser source and 1800 lines/mm grating. The acquisition time is 30 s with an accumulation of 4. The excitation power was ˜40 mW after passing through a 100× objective (MPLN100X, Olympus). Output spectra were background subtracted and vector and simplex normalized. The pure lipid reference standards were placed on glass slides for spontaneous Raman spectra measurement. All lipid subtype reference spectra were acquired in the same manner.

### Stimulated Raman Scattering Microscopy

An upright laser-scanning microscope (DIY multiphoton, Olympus) with a 25× water objective (XLPLN, WMP2, 1.05 NA, Olympus) was applied for near-IR throughput. Synchronized pulsed pump beam (tunable 720-990 nm wavelength, 5-6 ps pulse width, and 80 MHz repetition rate) and Stokes (wavelength at 1032 nm, 6 ps pulse width, and 80 MHz repetition rate) were supplied by a picoEmerald system (Applied Physics & Electronics) and coupled into the microscope. The pump and Stokes beams were collected in transmission by a high NA oil condenser (1.4 NA). A high O.D. shortpass filter (950 nm, Thorlabs) was used that would completely block the Stokes beam and transmit the pump beam only onto a Si photodiode for detecting the stimulated Raman loss signal. The output current from the photodiode was terminated, filtered, and demodulated in X with a zero phase shift by a lock-in amplifier (HF2LI, Zurich Instruments) at 20 MHz. The demodulated signal was fed into the FV3000 software module FV-OSR (Olympus) to form the image during laser scanning. All SRS images were obtained with a pixel dwell time 40 μs and a time constant of 30 μs. A stack of 512 pixel×512 pixel×76 images in the CH-stretching region took approximately 15 minutes to acquire. The PRM analysis of this image stack took less than 1 min. Laser power incident on the sample was approximately 40 mW. Stimulated Raman histology was performed following a known protocol⁴¹.

### Gas Chromatography Mass Spectrometry (GC-MS)

Hippocampal slices (n=4 per group) from 3 month old and 18 month old mice were homogenized in ethanol/water (1:1, v:v) and the homogenate were sent to Lipotype GmbH (Dresden, Germany) for mass spectrometry-based lipid analysis⁴². Lipids were extracted using a two-step chloroform/methanol procedure⁴³. Samples were spiked with internal lipid standard mixture containing: cardiolipin 14:0/14:0/14:0/14:0 (CL), ceramide 18:1;2/17:0 (Cer), diacylglycerol 17:0/17:0 (DAG), hexosylceramide 18:1;2/12:0 (HexCer), lyso-phosphatidate 17:0 (LPA), lyso-phosphatidylcholine 12:0 (LPC), lyso-phosphatidylethanolamine 17:1 (LPE), lyso-phosphatidylglycerol 17:1 (LPG), lyso-phosphatidylinositol 17:1 (LPI), lyso-phosphatidylserine 17:1 (LPS), phosphatidate 17:0/17:0 (PA), phosphatidylcholine 17:0/17:0 (PC), phosphatidylethanolamine 17:0/17:0 (PE), phosphatidylglycerol 17:0/17:0 (PG), phosphatidylinositol 16:0/16:0 (PI), phosphatidylserine 17:0/17:0 (PS), cholesterolester 20:0 (CE), sphingomyelin 18:1;2/12:0;0 (SM), triacylglycerol 17:0/17:0/17:0 (TAG) and cholesterol D6 (Chol). After extraction, the organic phase was transferred to an infusion plate and dried in a speed vacuum concentrator. First step dry extract was re-suspended in 7.5 mM ammonium acetate in chloroform/methanol/propanol (1:2:4, v:v:v) and 2nd step dry extract in 33% ethanol solution of methylamine in chloroform/methanol (0.003:5:1; v:v:v). All liquid handling steps were performed using Hamilton Robotics STARlet robotic platform with the Anti Droplet Control feature for organic solvents pipetting.

Samples were analyzed by direct infusion on a QExactive mass spectrometer (ThermoScientific) equipped with a TriVersa NanoMate ion source (Advion Biosciences). Samples were analyzed in both positive and negative ion modes with a resolution of Rm/z=200=280000 for MS and Rm/z=200=17500 for MSMS experiments, in a single acquisition. MSMS was triggered by an inclusion list encompassing corresponding MS mass ranges scanned in 1 Da increments⁴⁶. Both MS and MSMS data were combined to monitor CE, DAG and TAG ions as ammonium adducts; PC, PC O—, as acetate adducts; and CL, PA, PE, PE O—, PG, PI and PS as deprotonated anions. MS only was used to monitor LPA, LPE, LPE O—, LPI and LPS as deprotonated anions; Cer, HexCer, SM, LPC and LPC O— as acetate adducts and cholesterol as ammonium adduct of an acetylated derivative⁴⁵. Data were analyzed with in-house developed lipid identification software based on LipidXplorer⁴⁶. Data post-processing and normalization were performed using an in-house developed data management system. Only lipid identifications with a signal-to-noise ratio >5, and a signal intensity 5-fold higher than in corresponding blank samples were considered for further data analysis.

### Image Processing

SRS images were converted to unsigned 16 bit images via MATLAB, and were filtered using a morphological top-hat algorithm with 8 structuring elements, where appropriate. Unless used in ratiometric calculations, images for display were background subtracted using a sliding paraboloid with a radius of one tenth the image length. Intensity profiles and color maps were generated from ImageJ. All images within a figure use the same contrast unless specified otherwise. Ratiometric and overlaid images were created using the Image Calculator function and Overlay function, respectively, in ImageJ. Statistical analyses were performed using SPSS.

### Developing a Penalized Reference Matching Method

SRS HSI pixel spectral and reference spectra were linearly interpolated such that the spectral interval is 1 wavenumber. This ensures that the inner product, which requires vector dimensions to be the same, is possible. After all spectra were adjusted to the same interpolated resolution, they were simplex normalized using equation 1,

$${I}_{1} = \frac{I - {I}_{min}}{{I}_{max} - {I}_{min}} \qquad ( 1 )$$

where Iₘᵢₙ is the minimum value and Iₘₐₓ is the maximum value in the pixel spectrum. This normalization is done prior to reference matching so that the process generates results that are solely based on spectral shape without being affected by any intensity fluctuation. The normalized pixel spectra were then divided by their Euclidean norm as shown in equation 2:

$${I}_{2} = \frac{{I}_{1}}{{‖ {I}_{1} ‖}_{2}} \qquad ( 2 )$$

where I₂ is the interpolated signal of the pixel spectrum. Reference spectra from spontaneous Raman acquisitions follow the same pre-processing steps as the HSI pixel spectra, as shown in equations 3 and 4 below.

$${I}_{4} = \frac{{I}_{3} - {I}_{3 min}}{{I}_{3 max} - {I}_{3 min}} \qquad ( 3 )$$

$${I}_{5} = \frac{{I}_{4}}{{‖ {I}_{4} ‖}_{2}} \qquad ( 4 )$$

where I₃ denotes spontaneous Raman spectra, and I₅ is the interpolated signal of the reference spectrum. Due to the nature of Raman spectral intensity, similarity scores between each pixel spectrum and the reference spectrum were calculated using the dot product of I₂ and I₅.

These spectroscopic methods have been deployed for several decades, but due to high false positive rates, direct label-free characterization of multiple lipid subtypes in cells and tissues has not been achieved by using optical imaging. To address this, a penalty term was added to the canonical cosine similarity algorithm, which decreases the false positive rates by proportionally reducing the similarity score with the positional discrepancy to the best spectral match (FIGS. 2A-2C). This process is summarized as:

$$score = {max}_{i ∈ [ 1 , N ]} ( {u}_{i} \cdot v - αΔ {x}^{2} ) \qquad ( 5 )$$

where u represents the interpolated signal of a pixel's shifted spectrum at various positions; v represents the interpolated signal of the reference spectrum; a is the penalty coefficient, with a unit of [cm²]; Δxᵢ is the deviation in position of the spectrum in uᵢ from the initial observed position; and N is the number of interpolated signals, which depends on the spectral resolution of the HSI. The penalty term aΔx² inherently addresses the slight positional deviations due to the diverse chemical environment, as well as the variations in instrumentation such as thermoelectric noise, lensing, and other interference. Without this term, even if the spectral shape of a pixel matches the reference spectrum (FIG. 2A), the final similarity score may still be low when the positions of the peaks differ greatly (FIGS. 2B-2C). With the penalty term, all pixel spectra are evaluated as if they occur at multiple Raman shifts, and the highest similarity score is returned in a pixel-by-pixel manner.

By leveraging positional information in addition to peak amplitude shape, the breadth of similarity score is increased or decreased, akin to a change in contrast (FIGS. 2D-2F). This ensures that pixels with similar shapes and positions are scored accordingly.

Most images collected were taken from the Raman CH stretching region (2700 cm⁻¹ to 3150 cm⁻¹) with 75 total Raman shifts (a spectral distance of 6 cm⁻¹ between images). The position deviation Δx was the shift of peaks in the spectrum. Several values were assessed for the penalty coefficient and α=1×10⁴ was chosen. At a higher value (4×10⁴), the image contrast was to too high to show the full-range signals, whereas a lower α (0.25×10⁴) caused over-saturation in images (FIGS. 2D-2F). This is because if the penalty is too low, the pixel and reference spectra are free to shift themselves relative to each other until the highest similarity score is returned, no matter how far that shift may be from the original position. In addition, to show the capability of analysis based on CH stretching region signal only, the spectra of 38 lipid subtypes was fitted using four Gaussian peaks corresponding to functional groups defining lipid structures.

Since Raman spectra contain molecular bond information that correlates with concentration, similarity scores may be used to estimate the relative levels of different molecules, such as different lipid subtypes. When the Raman spectra of a sample exhibit a high degree of similarity to that of a reference standard, it will suggest a higher concentration of that reference molecule in the sample. Different biomolecules may have the same types of chemical bonds, and the cumulative mixture of various molecules may result in a spectrum that displays the same spectral shape as an unrelated molecule. From a macromolecular perspective in biological samples, however, we find that factors such as the diversity of the analyte composition do not necessarily void the correlation between relative rations and similarity scores.

PRM was further compared with pseudo-inverse matrix (PINV) multiplication and found that both PRM-based similarity scores and PINV-derived coefficients correlated with relative ratios of lipids. However, PINV-derived coefficients can have negative values and have unbounded ranges. Furthermore, calculations using PINV took much longer than PRM. Even though PINV coefficients intuitively classify similarity of random spectra as having no similarity (a value of 0), a perfect match may not have a coefficient of 1. Since the Raman spectra of biological samples are not entirely random, and share some general similarities, it is more important that the perfect matches be bound to a value of 1, even if the similarity scores of random spectra are not centered at 0. Furthermore, HSI are often acquired at various pixel densities and resolutions, which yield datasets of different sizes. Whether a 512×512 pixel or a 256×256 pixel, HSI is acquired for the same sample, the pixels corresponding to the same structures should have the same spectrum, and therefore the same similarity score. However, since PINV coefficients for the spectra in a HSI are not mutually exclusive, it may not be suitable for comparing different HSIs. Although similarity scores for Raman spectra in the CH-stretching region are typically close to 1, the variance within pixels of a pure sample is much lower. This shows that SRS HSI are suitable for PRM analysis.

### Mapping Cholesterol Levels in Drosophila Fat Body Using Reference Spectra

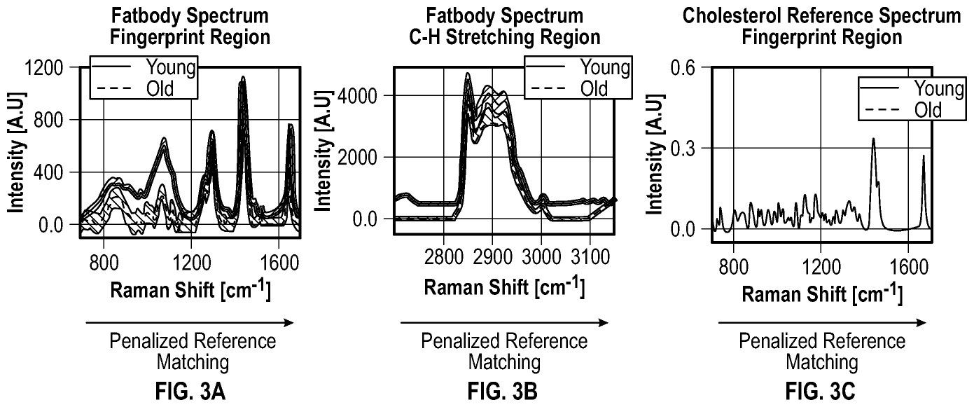

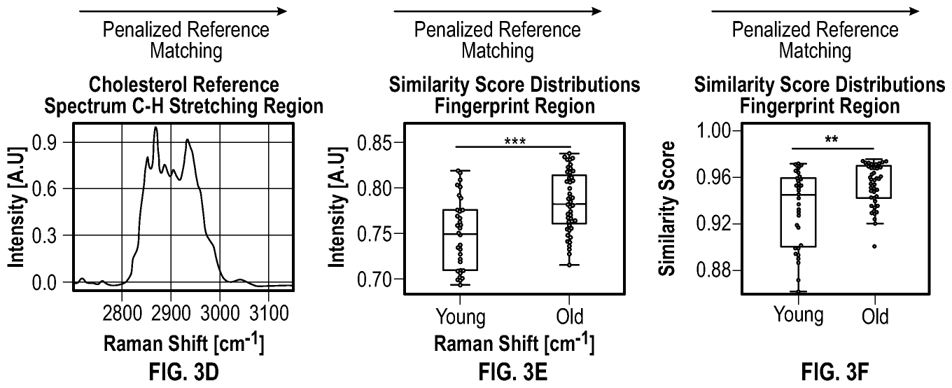

As a proof of concept, the PRM algorithm was applied to detecting and comparing cholesterol levels in fat body tissues of young and old Drosophila. Analogous to mammalian liver and adipose tissue, Drosophila fat body has been used extensively to study lipid metabolism. Fat body tissue spectra was collected from young and old flies using spontaneous Raman spectroscopy and compared them to reference spectra of cholesterol at the fingerprint (750 cm⁻¹ to 1650 cm⁻¹) and CH-stretching (2700 cm⁻¹ to 3150 cm⁻¹) regions (FIGS. 3A-3D). Although the fat body is known to be enriched in triacylglycerides (TAGs), PRM enabled us to extract cholesterol-matched signals in a TAG-rich environment using the cholesterol reference standard. Compared to samples from young flies, fat body samples from old flies showed significantly higher similarity scores to the cholesterol reference spectra in both regions (FIGS. 3E-3F), indicating elevated cholesterol content in old flies. This result is consistent with the published data¹⁴. This analysis demonstrates that the PRM algorithm as an effective method for rapid in situ lipid mapping in tissues.

Either the CH-stretching or fingerprint region in a Raman spectrum may be analyzed depending on the biological questions to address and the Raman scattering equipment available. Both regions can be used to analyze changes in biomolecule distribution, pathological structures (such as amyloid plaques) and other morphological characteristics¹⁵⁻¹⁹. Although both spectral regions yielded similar results, the fingerprint region generated results with a lower rejection level of p<0.001. This is likely because the fingerprint region contained more definitive features, and the CH-stretching region possessed low intensity shoulders below 2800 cm⁻¹ and above 3000 cm⁻¹, which may lead to a higher similarity score between samples since both spectral data sets matched in those regions where the intensity was zero. Importantly, this demonstrates that similarity scores generated from spectra data by PRM-SRS can be used to estimate the levels of biomolecules in the samples.

### Using PRM-SRS to Detect Cardiolipin Changes in Cells

After validating the efficacy and robustness of PRM on spontaneous Raman spectral analyses, the algorithm was also extended to the analysis of Stimulated Raman scattering (SRS) images. To evaluate the spatial accuracy and quantitative approximation of PRM-SRS, it was first benchmarked against fluorescence microscopy images. Using PRM-SRS imaging, cardiolipin (CL), an essential phospholipid in the inner mitochondrial membrane, was examined in cultured HEK293 cells. CL is synthesized in the inner mitochondrial membrane in consecutive reactions catalyzed by enzymes, including phosphatidylglycerophosphate synthase 1 (PGS1), phosphatidylglycerophosphate phosphatase (PTPMT1) and cardiolipin synthase (CLS1)^{20,21}. PGS1 is essential for CL synthesis, and expression of an enzyme-deficient mutant PGS1 leads to a reduction of PGP (Phosphatidylglycerophosphate) and CL in CHO cells²². Stable HEK293 cell lines were generated with downregulated PGS1 (shPGS1). PGS1 down-regulation was confirmed by immunofluorescence analysis using a PGS1-specific antibody. Following staining using nonyl acridine orange (NAO), a fluorescent dye with high affinity for CL²³, HEK293 cells were analyzed using both two-photon fluorescence (TPF) microscopy and PRM-SRS.

To demonstrate the specificity of SRS signals for CL, control cells were compared with shPGS1 cells. PRM-SRS analysis of the hyperspectral images was consistent with TPF images in both control and shPGS1 cells (FIGS. 4A-4B). Quantitative analyses of both PRM-SRS images and fluorescence images showed significant decreases of CL signals in shPGS1 cells compared with control cells (FIGS. 4C-4D). Importantly, the similarity score image of the reference-matched CL is distinct from any single Raman shift images in the CH-symmetric stretching regions. These results demonstrate the ability of PRM-SRS to quantitatively detect CL changes in cells, and its potential for visualizing lipid metabolic dynamics at the subcellular scale.

To compare the image similarity between fluorescence image and PRM-SRS image, similarity index and normalized mean square error were calculated. It was found that the similarity index between fluorescence images of NAO stained cardiolipin and PRM-SRS images of cardiolipin was higher than other lipid subtypes. Normalized mean squared error for cardiolipin is lower than that of other lipid subtypes, supporting the highest similarity between NAO stained cariolipin and PRM-SRS image of cardiolipin. Importantly, down-regulating PGS1, an enzyme critical for cardiolipin biosynthesis, significantly reduced NAO-staining signal and PRM-SRS measured cardiolipin signal, supporting that PRM-SRS measured cardiolipin signals reflect the cardiolipin levels in the samples. These results of similarity comparison show that PRM-SRS describes the cardiolipin distribution well.

### PRM-SRS Tracking Clinically Relevant Lipid Subtype Biomarkers in Human Kidney Tissue

PRM-SRS was then applied to characterizing lipid subtypes in human kidney tissues, a structurally and functionally highly complex tissue composed of more than 50 cell types²⁴. Cholesterol, ceramides (Cer), and triacylglycerides are among the most abundant lipid species in the kidney. Dyslipidemia is frequently observed in nephrotic syndrome (NS) and various types of chronic kidney disease (CKD)²⁵. The glomerulus, the filtration unit of the nephron, is a network of capillaries that sequesters lipid species as an initial step of filtration and is decorated with lipid droplets. Wrapping around the capillary of the glomerular tuft are podocytes, making up the visceral epithelial lining of the Bowman's capsule. Healthy reference human kidney tissue sections were used as a control to showcase the application of our PRM-SRS in imaging different lipid subtypes in structurally complex tissue samples.

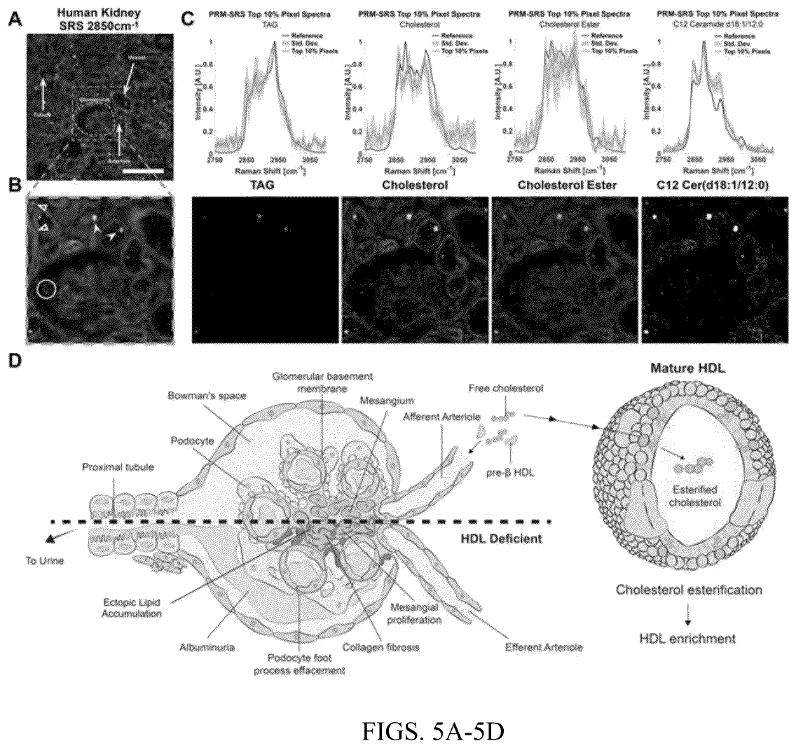

SRS imaging detected the overall distribution of lipids in the morphologically distinct structures in these kidney tissues, such as glomeruli, tubules and blood vessels (FIGS. 5A-5B). Using PRM-SRS, the relative concentrations of lipids were estimated in different structures, such as lipid droplets in podocytes and eosinophilic bodies near tubules (FIGS. 5A-5B). PRM-SRS imaging revealed distributions of distinct lipid subtypes in the glomerulus and surrounding structures in situ, including (TAG), cholesterol, cholesterol ester and C12 ceramide, with the 90^{th} percentile similarity scores to the corresponding pure lipid reference spectra (FIG. 5C).

Dyslipidemia is manifested as elevated levels of serum TAGs, cholesterol, and very low to intermediate density lipoproteins. Common initial abnormalities include decreased production and activity of lecithin-cholesterol acyltransferase which decreases high-density lipoprotein (HDL) levels and maturation of HDL cholesterol²⁶. The regulation of HDL cholesterol is tightly controlled by several organs, but generally entails the esterification of cholesterol into cholesterol esters, which move towards the center of HDL particles, along with neutral TAGs. This maintains a favorable cholesterol gradient as these HDL particles become enriched by sequestering cholesterols and fatty acids from other lipoproteins. Although mature lipoproteins are too large to pass the glomerular filtration barrier, lipids and lipid-bound proteins from lipoproteins may affect overall renal lipid metabolism²⁷. Ratiometric imaging revealed that there is a greater amount of non-esterified cholesterol in the lipid particles than neighboring structures. These pools of cholesterol may represent those yet to be enriched or ectopic deposits. Ceramides are also abundant in the kidney and play a crucial role in regulating cellular processes and binding cholesterol and other lipoproteins²⁸. Ceramides, e.g., C12 ceramide, show high similarity with pixel spectra in lipid droplets and lipoprotein particles (FIG. 5C). In nephropathies, ectopic lipid deposits in the glomerular mesangium and proximal tubules are typically concurrent with low HDL levels²⁶. Other characteristics of glomerular nephropathies are depicted in FIG. 5D. The ability of PRM-SRS to track the lipidomic profile in tissues collected from patients at various stages of diseases will generate critical data for changes in these macromolecules over time, and with associated biological variables, providing insights into assessing severity, progression or prognosis of various lipid metabolic diseases.

### Mapping Lipid Subtype Distributions in Drosophila Fat Body

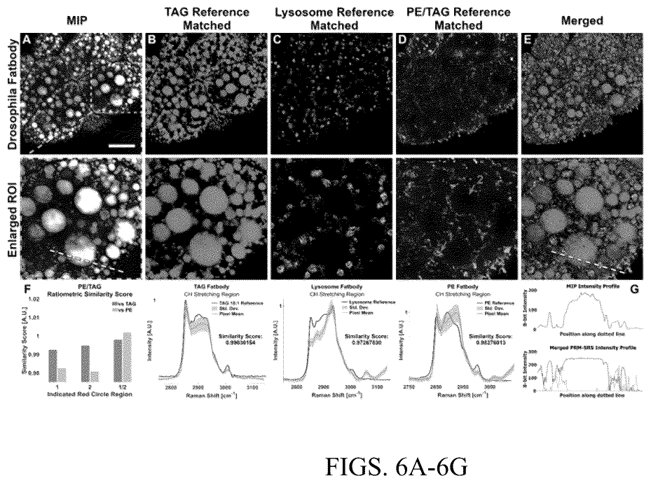

Using maximum intensity projection (MIP) of the PRM-SRS hyperspectral image of total lipids, lipid droplets were visualized in Drosophila fat body cells (FIG. 6A). Lipid subtypes were also detected using different lipid reference standards, including TAG and phosphatidylethanolamine (PE). In addition to detecting lipid subtypes, PRM-SRS can also provide information on subcellular distribution, including co-localization, of different lipid subtypes. Comparison of MIP of the PRM-SRS hyperspectral image of total lipids (FIG. 6A) with mono-unsaturated triacylglycerol (TAG 18:1) reference-matched image (FIG. 6B) revealed abundant TAG in lipid droplets (FIGS. 6A-6B). A critical tenant of unmixing techniques such as PRM is that spectral shape, not intensity, is what drives the similarity score of normalized spectra. The MIP in FIG. 6A shows several lipid droplets with non-uniform maximum intensities, yet the TAG reference matched image shows a more uniform result. This was because despite intensity differences that may have arisen from the sample focus plane, the spectral shapes were still consistent. Drosophila fat body cells contain lysosome-like structures that regulate their lipid anabolism and were detected using reference spectra of lysosome-like structures of the fat body (FIG. 6C). These spectra, unlike the lipid subtypes, have a more dominant CH₃ stretching peak at 2935 cm⁻¹, and a more pronounced olefinic peak at 3065 cm⁻¹. PE is one of the most prominent lipid subtypes in cell/organelle membranes and can be visualized by taking PRM-SRS images using their corresponding reference standard. FIG. 6D shows the spatial distribution of the ratio of the PE and TAG similarity scored images. Upon closer inspection, FIG. 6F shows the spectra of the apparent pixels are similar to TAG, and therefore appear darker in those regions in both the TAG and PE similarity scored images. However, the lipid cores have a greater disparity in these similarity scores, with an even greater similarity to TAG and lesser similarity to PE. Therefore, the apparent pixels are visible because of relative concentrations. The intensity profiles (FIG. 6G) support the notion that signal intensity of images based on similarity scores varies by spectral shape, whereas signal intensity in SRS images varies by chemical bond concentrations. Thus, a lipid droplet core may appear more uniform in a TAG reference-matched PRM-SRS image than in an original SRS image of the CH₂ stretching region. Together, these data demonstrate that PRM-SRS is useful in detecting different lipid subtypes and their distribution at the subcellular scale.

### Analyzing Lipid Subtypes in Mouse Brain Samples

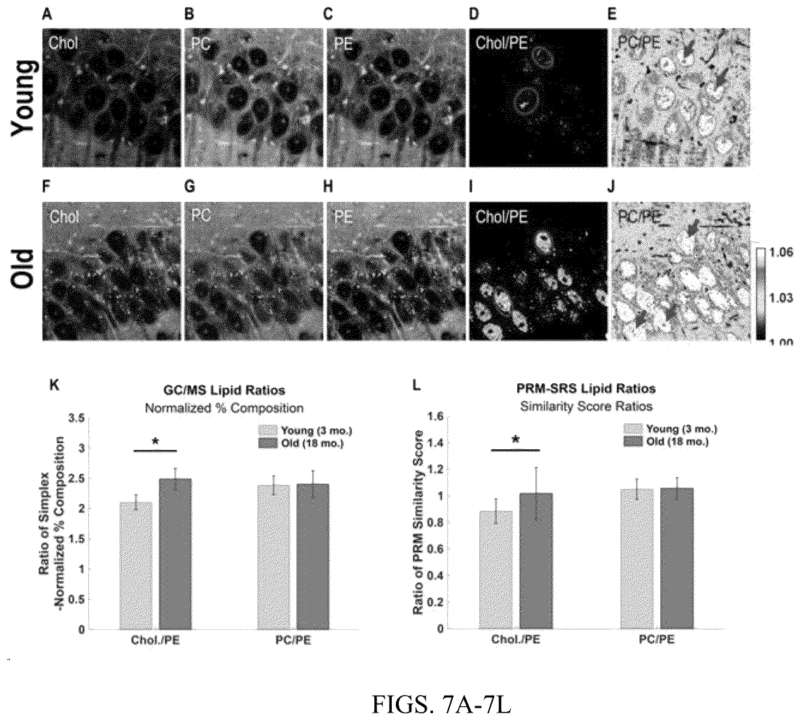

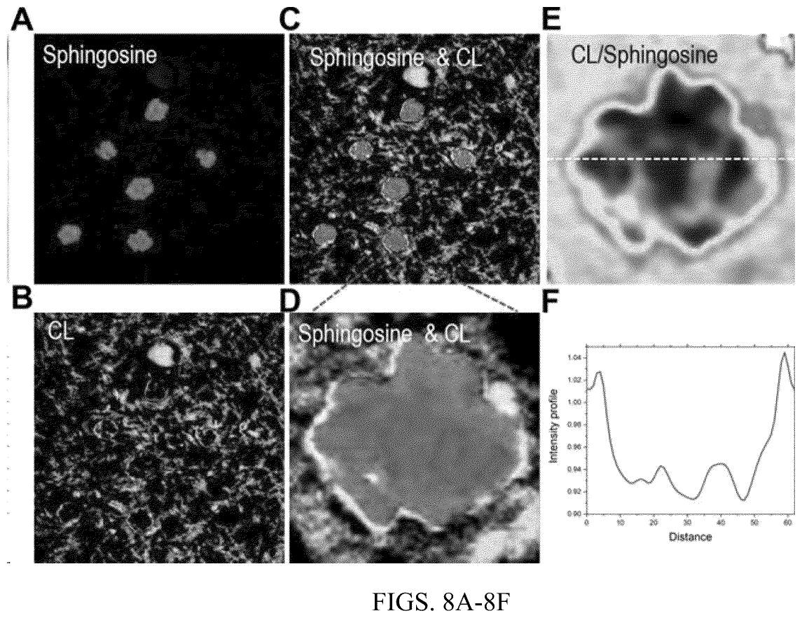

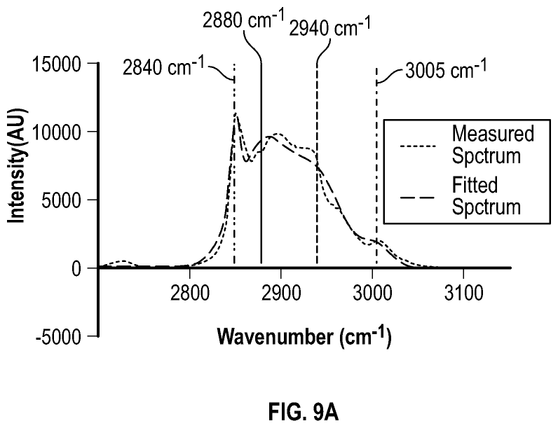

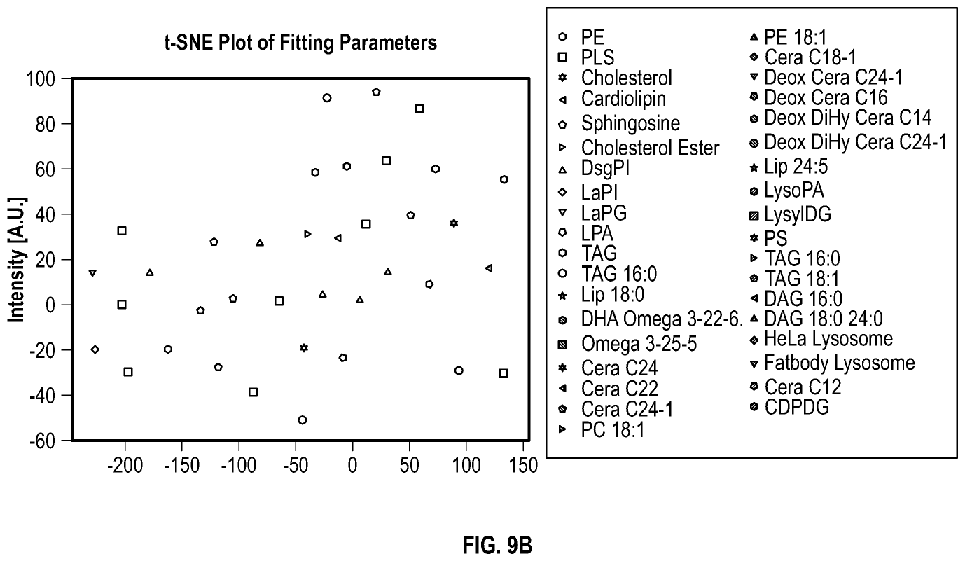

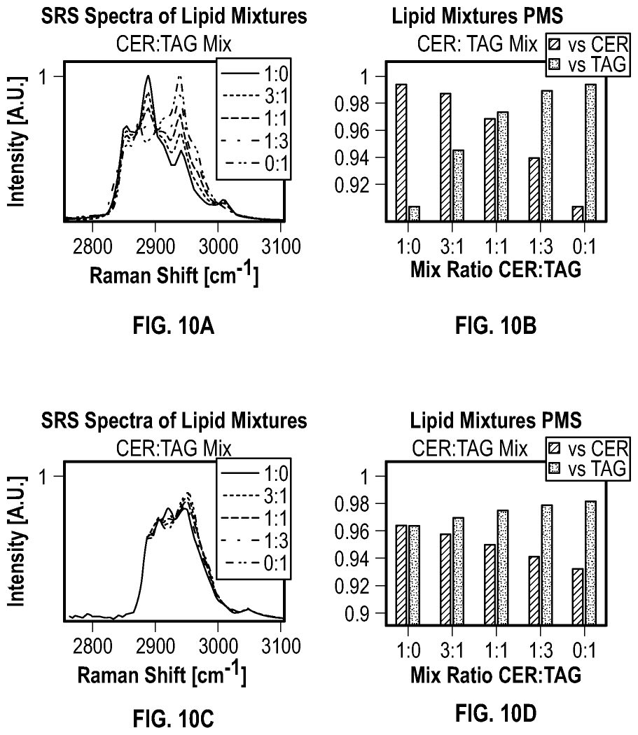

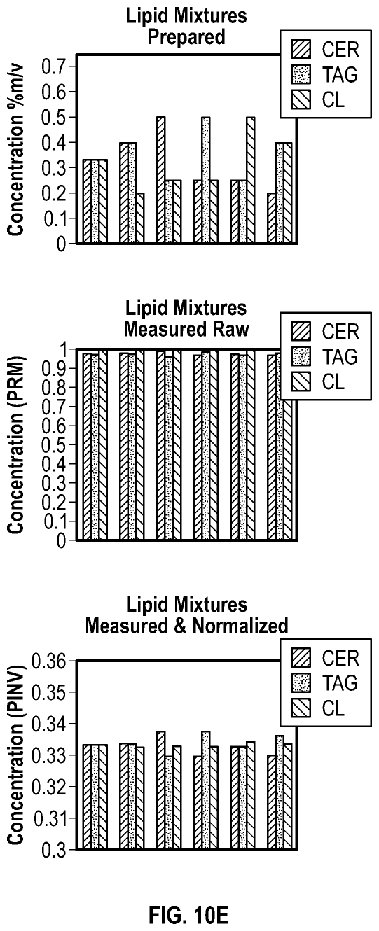

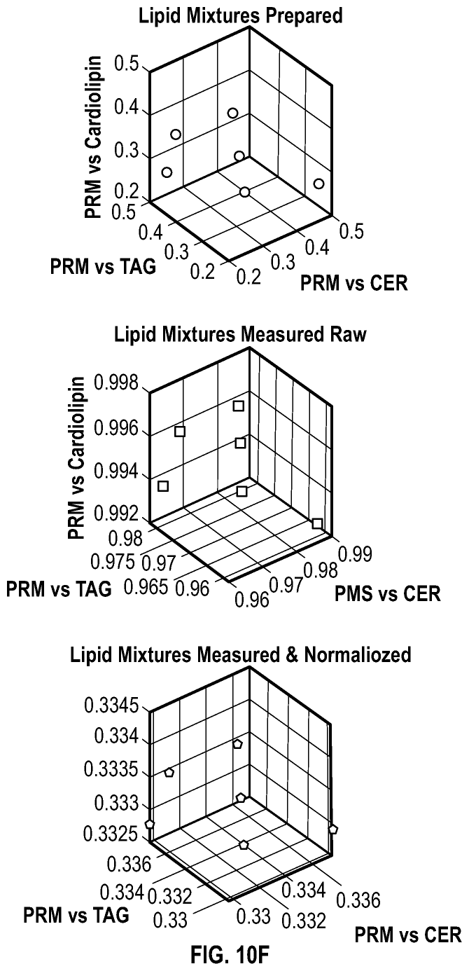

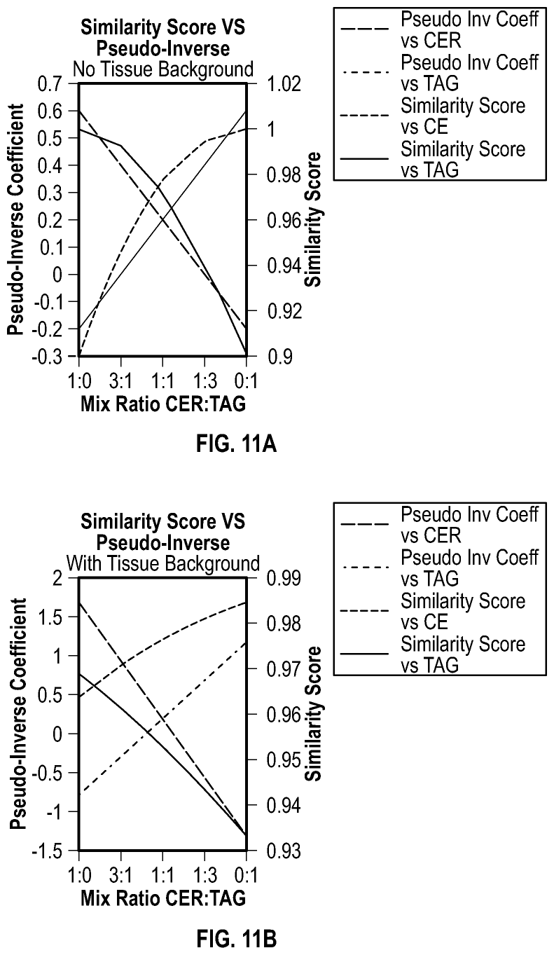

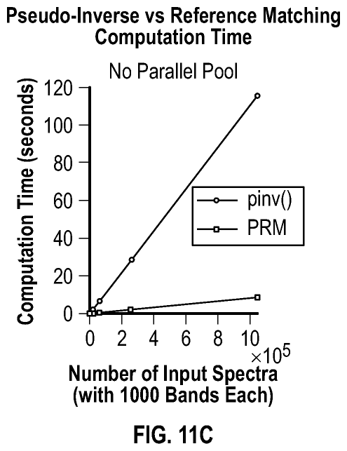

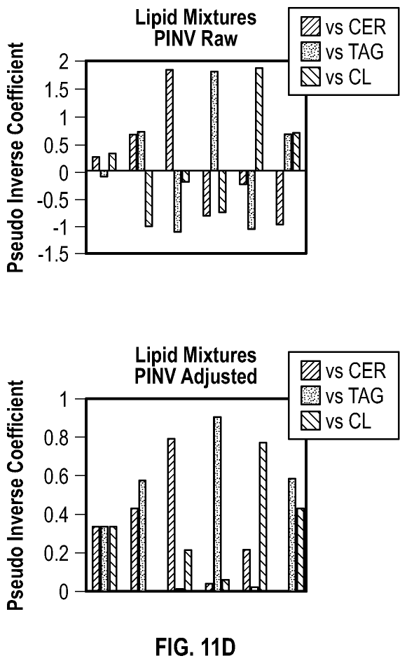

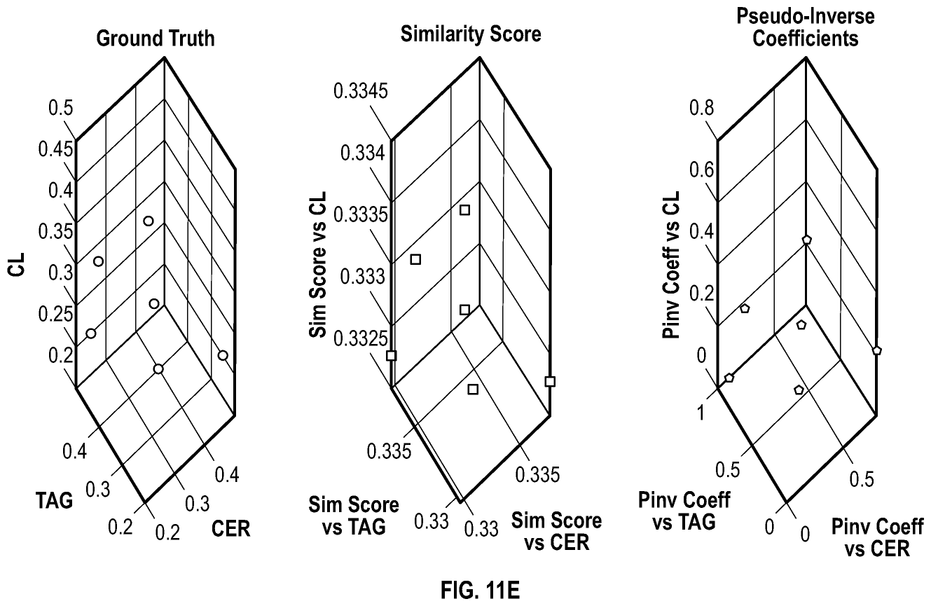

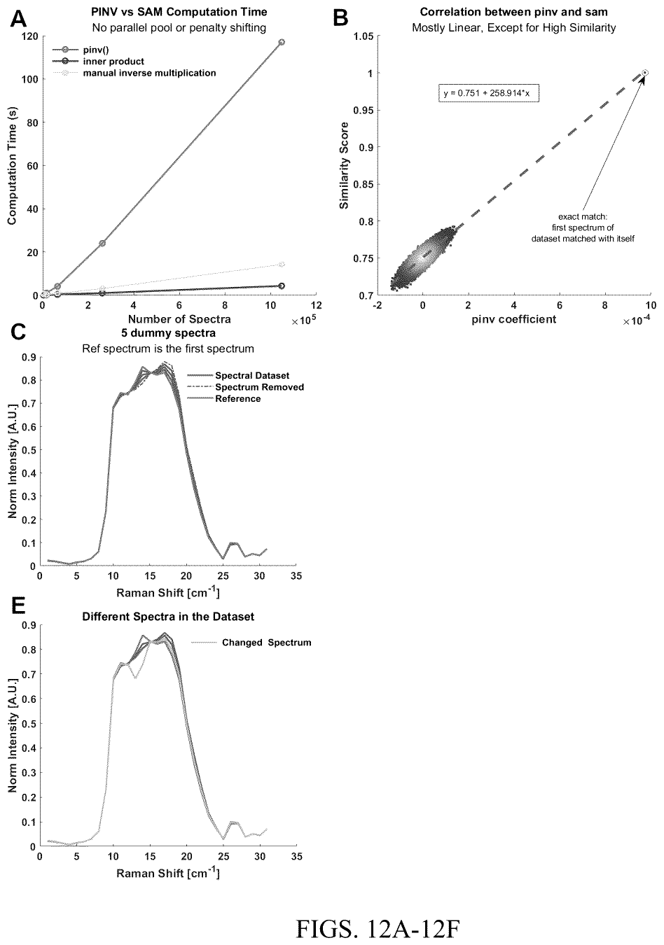

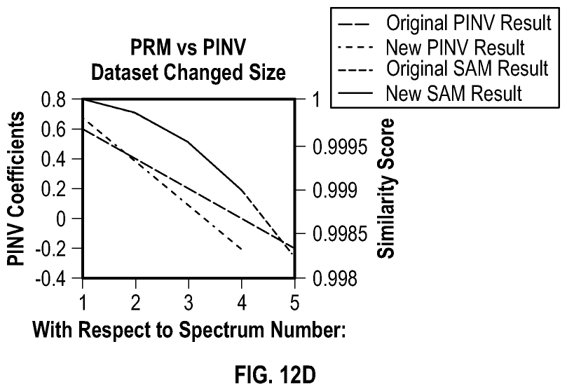

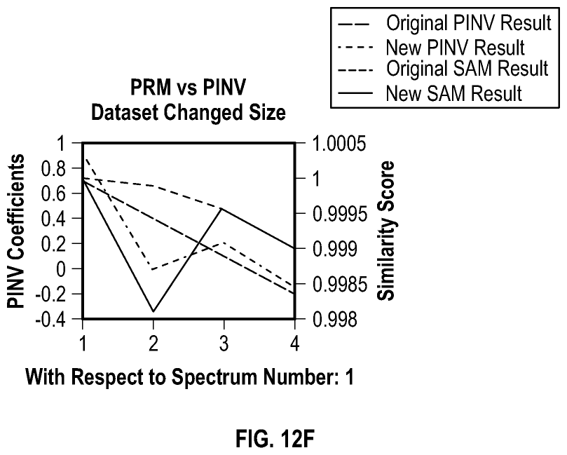

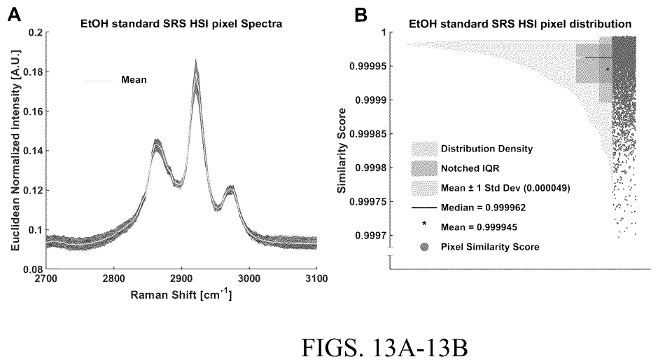

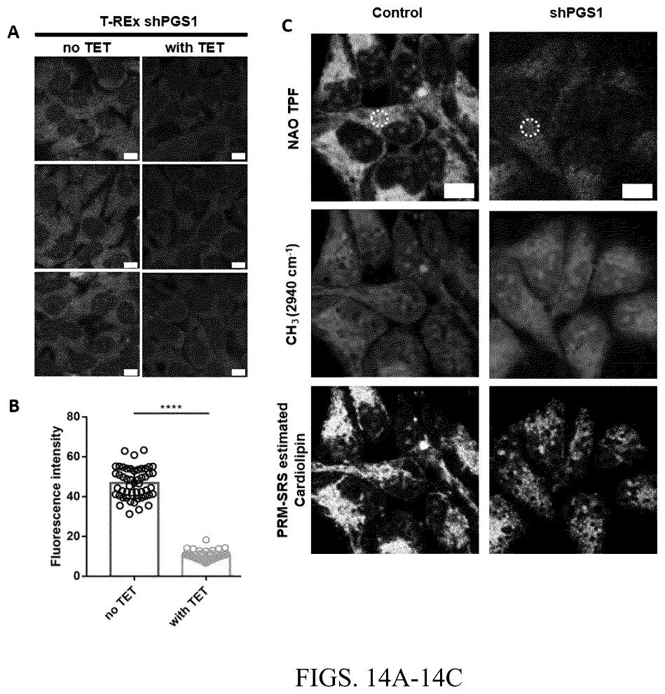

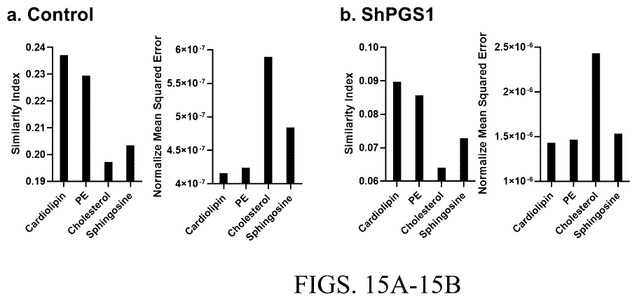

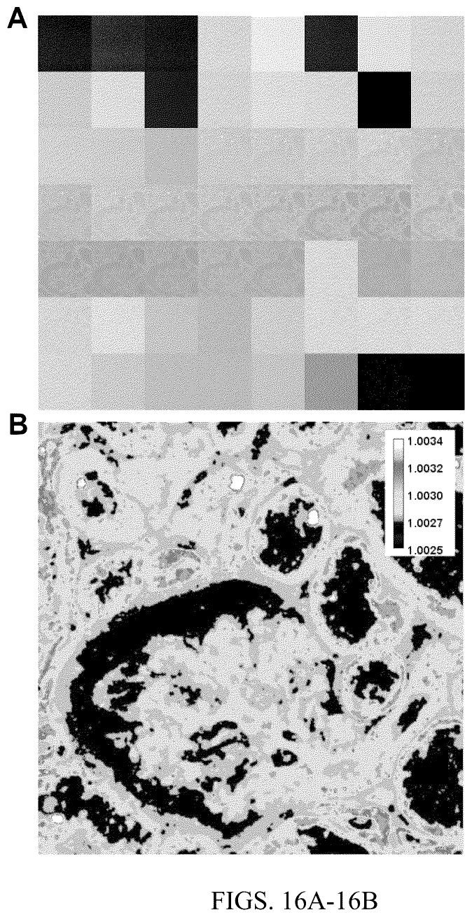

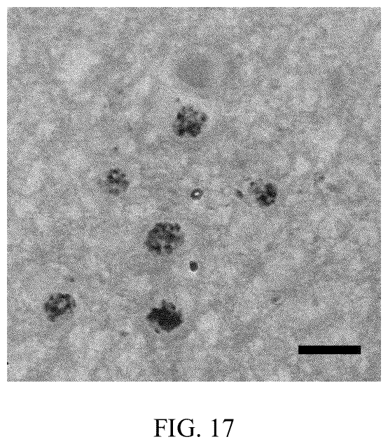

PRM-SRS was also applied to analyzing lipid metabolism in the context of the aging using mouse hippocampal samples. Cholesterol, PC, and PE levels were visualized and compared in hippocampal samples from young (3 months) and old (18 months) mice (FIGS. 7A-7C, FIGS. 7F-7G). Ratiometric images were also generated for quantitative analysis, since the signal intensity has a linear relationship with the concentration of chemical bonds of the molecules detected. Ratiometric imaging analyses showed increased Cholesterol/PE ratio in subregions of granule cell nuclei (red circles) (FIG. 7D, FIG. 7I). This increase in the Cholesterol/PE ratio was more prominent and detected in more granule cells in the old brain samples as compared with the young ones (compare FIG. 7D with FIG. 7I), indicative of altered cholesterol and/or PE metabolism in the old brains. These results show that ratiometric PRM-SRS imaging can detect changes in differential spatial distribution of various lipid subtypes even when such changes are not obvious in images of individual lipid subtypes.

Ratiometric images of PC/PE showed higher levels of PC relative to PE in the granule cell nuclei of the dentate gyms in both young and old mice, but lower levels outside the nuclear regions (FIG. 7E, FIG. 7J). Compared to the young brain sample, the old brain sample showed no significant changes in the average PC or PE levels in the granule cells in both individual imaging channels (FIGS. 7B-7C, FIGS. 7G-7H), and the ratiometric images (FIG. 7E, FIG. 7J). This is consistent with the results from Gas Chromatography Mass Spectrometry (GC-MS) (FIGS. 7K-7L). However, spatial distribution differences were observed in the PC to PE ratio between young and old samples. The ratiometric images reveal that more granule cell nuclei had uniformly higher PC/PE ratio in the old brain sample, whereas the nuclei in the young sample showed less even distribution of the PC/PE ratio (red areas; nuclei marked by purple arrows) (FIG. 7E, FIG. 7J). These data suggest altered synthesis, accumulation or clearance of PC and/or PE in the granule cells in the old brains, consistent with previous observations²⁹. Since PE is a precursor of PC, higher PC to PE ratios inside the older hippocampal granule cells suggest that aging brains may have altered CTP:phosphocholinecytidylyl transferase (CCT) activity—a rate limiting PC synthesis enzyme with a predominantly nuclear localization³⁰. This is significant because both PRM-SRS imaging and GC-MS analysis show that the younger brain samples contain less cholesterol relative to PE than old ones. However, differential subcellular distribution of lipids, including cholesterol/PE and PC/PE ration in the nuclei, were only able to be detected through ratiometric analysis (FIGS. 7D-7E, FIGS. 7I-7J).

For comparison, the same samples were analyzed using GC-MS to quantify cholesterol/PE and PC/PE ratios (FIG. 7K), which demonstrated an increased cholesterol/PE ratio and no changes in the PC/PE ratio in old brain samples compared with young ones. The PRM-SRS images of nuclei in the tissues were manually segmented using ImageJ for quantification of cholesterol/PE and PC/PE ratios (FIG. 7L). These data suggest that PRM-SRS may be used for quantitative lipidomic imaging analyses in tissue samples in the future.

### Detecting Lipid Subtype Distributions in Human Brain Tissues

Sphingosine is another crucial lipid subtype whose metabolic alteration has been suggested as a biomarker for neurodegenerative diseases, such as Alzheimer's, Parkinson's, and Huntington's diseases^{4,31}. To visualize individual cells, label-free optical SRS histology (SRH) imaging of human brain sample was used to create virtual histology images similar to that of hematoxylin-and-eosin (H&E) staining³⁵. Using PRM-SRS, sphingosine and CL were visualized simultaneously in the human brain tissue sections (FIGS. 8A-8B). Superimposition of sphingosine and CL images illustrates their relative distribution in brain cells (FIGS. 8C-8D). Ratiometric imaging (FIG. 8E) and quantitative analyses (FIG. 8F) demonstrated a clear reduction in the CL to sphingosine ratio inside the nucleus, consistent with the fact that CL is mainly localized at the inner mitochondrial membrane but not in the nucleus. These results show that PRM-SRS can be used to visualize subcellular distribution of different lipid subtypes.

### REFERENCES

1. Wong, M. W. K., Braidy, N., Pickford, R., Vafaee, F., Crawford, J., Muenchhoff, J., Schofield, P., Attia, J., Brodaty, H., Sachdev, P. and Poljak, A., “Plasma lipidome variation during the second half of the human lifespan is associated with age and sex but minimally with BMI,” PloS One 14(3), e0214141 (2019).
2. Han, X. and Gross, R. W., “Shotgun lipidomics: Electrospray ionization mass spectrometric analysis and quantitation of cellular lipidomes directly from crude extracts of biological samples,” Mass Spectrom. Rev. 24(3), 367-412 (2005).
3. Jové, M., Naudí, A., Gambini, J., Borras, C., Cabré, R., Portero-Otín, M., Viña, J. and Pamplona, R., “A Stress-Resistant Lipidomic Signature Confers Extreme Longevity to Humans,” J. Gerontol. Ser. A 72(1), 30-37 (2017).
4. Montoliu, I., Scherer, M., Beguelin, F., DaSilva, L., Mari, D., Salvioli, S., Martin, F.-P. J., Capri, M., Bucci, L., Ostan, R., Garagnani, P., Monti, D., Biagi, E., Brigidi, P., Kussmann, M., Rezzi, S., Franceschi, C. and Collino, S., “Serum profiling of healthy aging identifies phospho- and sphingolipid species as markers of human longevity,” Aging 6(1), 9-25 (2014).
5. Hammond, G. R. V., Schiavo, G. and Irvine, R. F., “Immunocytochemical techniques reveal multiple, distinct cellular pools of PtdIns4P and PtdIns(4,5)P(2),” Biochem. J. 422(1), 23-35 (2009).
6. Baron, C. L. and Malhotra, V., “Role of diacylglycerol in PKD recruitment to the TGN and protein transport to the plasma membrane,” Science 295(5553), 325-328 (2002).
7. Fung, A. A. and Shi, L., “Mammalian cell and tissue imaging using Raman and coherent Raman microscopy,” WIREs Syst. Biol. Med. 12(6), e1501 (2020).
8. Shi, L., Fung, A. A. and Zhou, A., “Advances in stimulated Raman scattering imaging for tissues and animals,” Quant. Imaging Med. Surg. 11(3), 1078101-1071101 (2021).
9. Oh, S., Lee, C., Yang, W., Li, A., Mukherjee, A., Basan, M., Ran, C., Yin, W., Tabin, C. J., Fu, D., Xie, X. S. and Kirschner, M. W., “Protein and lipid mass concentration measurement in tissues by stimulated Raman scattering microscopy,” Proc. Natl. Acad. Sci. 119(17), e2117938119 (2022).
10. Zhang, J., Zhao, J., Lin, H., Tan, Y. and Cheng, J.-X., “High-Speed Chemical Imaging by Dense—Net Learning of Femtosecond Stimulated Raman Scattering,” J. Phys. Chem. Lett. (2020).
11. Huang, K.-C., Li, J., Zhang, C., Tan, Y. and Cheng, J.-X., “Multiplex Stimulated Raman Scattering Imaging Cytometry Reveals Lipid-Rich Protrusions in Cancer Cells under Stress Condition,” iScience 23(3), 100953 (2020).
12. Felten, J., Hall, H., Jaumot, J., Tauler, R., de Juan, A. and Gorzsás, A., “Vibrational spectroscopic image analysis of biological material using multivariate curve resolution-alternating least squares (MCR-ALS),” Nat. Protoc. 10(2), 217-240 (2015).
13. Gaifulina, R., Maher, A. T., Kendall, C., Nelson, J., Rodriguez-Justo, M., Lau, K. and Thomas, G. M., “Label-free Raman spectroscopic imaging to extract morphological and chemical information from a formalin-fixed, paraffin-embedded rat colon tissue section,” Int. J. Exp. Pathol. 97(4), 337-350 (2016).
14. Martin, M., Dotti, C. G. and Ledesma, M. D., “Brain cholesterol in normal and pathological aging,” Biochim. Biophys. Acta 1801(8), 934-944 (2010).
15. Ji, M., Arbel, M., Zhang, L., Freudiger, C. W., Hou, S. S., Lin, D., Yang, X., Bacskai, B. J. and Xie, X. S., “Label-free imaging of amyloid plaques in Alzheimer's disease with stimulated Raman scattering microscopy,” Sci. Adv. 4(11), eaat7715 (2018).
16. Michael, R., Lenferink, A., Vrensen, G. F. J. M., Gelpi, E., Barraquer, R. I. and Otto, C., “Hyperspectral Raman imaging of neuritic plaques and neurofibrillary tangles in brain tissue from Alzheimer's disease patients,” Sci. Rep. 7(1), 15603 (2017).
17. Li, S., Luo, Z., Zhang, R., Xu, H., Zhou, T., Liu, L. and Qu, J., “Distinguishing Amyloid β-Protein in a Mouse Model of Alzheimer's Disease by Label-Free Vibrational Imaging,” 10, Biosensors 11(10), 365 (2021).
18. Suzuki, Y., Kobayashi, K., Wakisaka, Y., Deng, D., Tanaka, S., Huang, C.-J., Lei, C., Sun, C.-W., Liu H., Fujiwaki, Y., Lee, S., Isozaki, A., Kasai, Y., Hayakawa, T., Sakuma, S., Arai, F., Koizumi, K., Tezuka, H., Inaba, M., et al., “Label-free chemical imaging flow cytometry by high-speed multicolor stimulated Raman scattering,” Proc. Natl. Acad. Sci. 116(32), 15842-15848 (2019).
19. Chau, A. H., Motz, J. T., Gardecki, J. A., Waxman, S., Bouma, B. E. and Tearney, G. J., “Fingerprint and high-wavenumber Raman spectroscopy in a human-swine coronary xenograft in vivo,” J. Biomed. Opt. 13(4), 040501 (2008).
20. Schlame, M. and Greenberg, M. L., “Biosynthesis, remodeling and turnover of mitochondrial cardiolipin,” Biochim. Biophys. Acta Mol. Cell Biol. Lipids 1862(1), 3-7 (2017).
21. Acoba, M. G., Senoo, N. and Claypool, S. M., “Phospholipid ebb and flow makes mitochondria go,” J. Cell Biol. 219(8), e202003131 (2020).
22. Kawasaki, K., Kuge, O., Chang, S. C., Heacock, P. N., Rho, M., Suzuki, K., Nishijima, M. and Dowhan, W., “Isolation of a chinese hamster ovary (CHO) cDNA encoding phosphatidylglycerophosphate (PGP) synthase, expression of which corrects the mitochondrial abnormalities of a PGP synthase-defective mutant of CHO-K1 cells,” J. Biol. Chem. 274(3), 1828-1834 (1999).
23. Jacobson, J., Duchen, M. R. and Heales, S. J. R., “Intracellular distribution of the fluorescent dye nonyl acridine orange responds to the mitochondrial membrane potential: implications for assays of cardiolipin and mitochondrial mass,” J. Neurochem. 82(2), 224-233 (2002).
24. Lake, B. B., Menon, R., Winfree, S., Hu, Q., Ferreira, R. M., Kalhor, K., Barwinska, D., Otto, E. A., Ferkowicz, M., Diep, D., Plongthongkum, N., Knoten, A., Urata, S., Naik, A. S., Eddy, S., Zhang, B., Wu, Y., Salamon, D., Williams, J. C., et al., “An atlas of healthy and injured cell states and niches in the human kidney,” bioRxiv 2021.07.28.454201 (2021).
25. Baek, J., He, C., Afshinnia, F., Michailidis, G. and Pennathur, S., “Lipidomic approaches to dissect dysregulated lipid metabolism in kidney disease,” Nat. Rev. Nephrol. 18(1), 38-55 (2022).
26. Vaziri, N. D., “HDL abnormalities in nephrotic syndrome and chronic kidney disease,” Nat. Rev. Nephrol. 12(1), 37-47 (2016).
27. Yang, H., Fogo, A. B. and Kon, V., “Kidneys: Key Modulators of HDL Levels and Function,” Cum Opin. Nephrol. Hypertens. 25(3), 174-179 (2016).
28. Srivastava, S. P., Shi, S., Koya, D. and Kanasaki, K., “Lipid mediators in diabetic nephropathy,” Fibrogenesis Tissue Repair 7(1), 12 (2014).
29. Gibellini, F. and Smith, T. K., “The Kennedy pathway-De novo synthesis of phosphatidylethanolamine and phosphatidylcholine,” IUBMB Life, n/a-n/a (2010).
30. Haider, A., Wei, Y.-C., Lim, K., Barbosa, A. D., Liu, C.-H., Weber, U., Mlodzik, M., Oras, K., Collier, S., Hussain, M. M., Dong, L., Patel, S., Alvarez-Guaita, A., Saudek, V., Jenkins, B. J., Koulman, A., Dymond, M. K., Hardie, R. C., Siniossoglou, S., et al., “PCYT1A Regulates Phosphatidylcholine Homeostasis from the Inner Nuclear Membrane in Response to Membrane Stored Curvature Elastic Stress,” Dev. Cell 45(4), 481-495.e8 (2018).
31. Di Pardo, A., Amico, E., Basit, A., Armirotti, A., Joshi, P., Neely, M. D., Vuono, R., Castaldo, S., Digilio, A. F., Scalabrí, F., Pepe, G., Elifani, F., Madonna, M., Jeong, S. K., Park, B.-M., D'Esposito, M., Bowman, A. B., Barker, R. A. and Maglione, V., “Defective Sphingosine-1-phosphate metabolism is a druggable target in Huntington's disease,” Sci. Rep. 7(1), 5280 (2017).
32. de Wit, N. M., den Hoedt, S., Martinez-Martinez, P., Rozemuller, A. J., Mulder, M. T. and de Vries, H. E., “Astrocytic ceramide as possible indicator of neuroinflammation,” J. Neuroinflammation 16(1), 48 (2019).
33. Murley, A. G., Jones, P. S., Coyle Gilchrist, I., Bowns, L., Wiggins, J., Tsvetanov, K. A. and Rowe, J. B., “Metabolomic changes associated with frontotemporal lobar degeneration syndromes,” J. Neurol. 267(8), 2228-2238 (2020).
34. Kim, W. S., He, Y., Phan, K., Ahmed, R. M., Rye, K.-A., Piguet, O., Hodges, J. R. and Haliday, G. M., “Altered High Density Lipoprotein Composition in Behavioral Variant Frontotemporal Dementia,” Front. Neurosci. 12, 847 (2018).
35. Orringer, D. A., Pandian, B., Niknafs, Y. S., Hollon, T. C., Boyle, J., Lewis, S., Garrard, M., Hervey-Jumper, S. L., Garton, H. J. L., Maher, C. O., Heth, J. A., Sagher,)., Wilkenson, D. A., Snuderl, M., Venneti, S., Ramkissoon, S. H., McFadden, K. A., Fisher-Hubbard, A., Lieberman, A. P., et al., “Rapid intraoperative histology of unprocessed surgical specimens via fibre-laser-based stimulated Raman scattering microscopy,” 2, Nat. Biomed. Eng. 1(2), 1-13 (2017).
36. Ledeen, R. W. and Wu, G., “Sphingolipids of the nucleus and their role in nuclear signaling,” Biochim. Biophys. Acta BBA—Mol. Cell Biol. Lipids 1761(5), 588-598 (2006).
37. Dominguez, G., Maddelein, M.-L., Pucelle, M., Nicaise, Y., Maurage, C.-A., Duyckaerts, C., Cuvillier, O. and Delisle, M.-B., “Neuronal sphingosine kinase 2 subcellular localization is altered in Alzheimer's disease brain,” Acta Neuropathol. Commun. 6(1), 25 (2018).
38. Shi, L., Zheng, C., Shen, Y., Chen, Z., Silveira, E. S., Zhang, L., Wei, M., Liu, C., de Sena-Tomas, C., Targoff, K. and Min, W., “Optical imaging of metabolic dynamics in animals,” Nat. Commun. 9(1), 2995 (2018).
39. Matthäus, C., Krafft, C., Dietzek, B., Brehm, B. R., Lorkowski, S. and Popp, J., “Noninvasive Imaging of Intracellular Lipid Metabolism in Macrophages by Raman Microscopy in Combination with Stable Isotopic Labeling,” Anal. Chem. 84(20), 8549-8556 (2012).
40. Fung, A. A., Hoang, K., Zha, H., Chen, D., Zhang, W. and Shi, L., “Imaging Sub-Cellular Methionine and Insulin Interplay in Triple Negative Breast Cancer Lipid Droplet Metabolism,” Front. Oncol. 12 (2022).
41. Wang, F., Chen, X., Cheng, H., Song, L., Liu, J., Caplan, S., Zhu, L. and Wu, J. Y., “MICAL2PV suppresses the formation of tunneling nanotubes and modulates mitochondrial trafficking,” EMBO Rep. 22(7), e52006 (2021).
42. Bigio, E. H., Mishra, M., Hatanpaa, K. J., White, C. L., Johnson, N., Rademaker, A., Weitner, B. B., Deng, H.-X., Dubner, S. D., Weintraub, S. and Mesulam, M., “TDP-43 pathology in primary progressive aphasia and frontotemporal dementia with pathologic Alzheimer disease,” Acta Neuropathol. (Berl.) 120(1), 43-54 (2010).
43. Wang, P., Deng, J., Dong, J., Liu, J., Bigio, E. H., Mesulam, M., Wang, T., Sun, L., Wang, L., Lee, A. Y.-L., McGee, W. A., Chen, X., Fushimi, K., Zhu, L. and Wu, J. Y., “TDP-43 induces mitochondrial damage and activates the mitochondrial unfolded protein response,” PLoS Genet. 15(5), e1007947 (2019).
44. Sampaio, J. L., Gerl, M. J., Klose, C., Ejsing, C. S., Beug, H., Simons, K. and Shevchenko, A., “Membrane lipidome of an epithelial cell line,” Proc. Natl. Acad. Sci. U.S.A. 108(5), 1903-1907 (2011).
45. Ejsing, C. S., Sampaio, J. L., Surendranath, V., Duchoslav, E., Ekroos, K., Klemm, R. W., Simons, K. and Shevchenko, A., “Global analysis of the yeast lipidome by quantitative shotgun mass spectrometry,” Proc. Natl. Acad. Sci. U.S.A. 106(7), 2136-2141 (2009).
46. Surma, M. A., Herzog, R., Vasilj, A., Klose, C., Christinat, N., Morin-Rivron, D., Simons, K., Masoodi, M. and Sampaio, J. L., “An automated shotgun lipidomics platform for high throughput, comprehensive, and quantitative analysis of blood plasma intact lipids,” Eur. J. Lipid Sci. Technol. 117(10), 1540-1549 (2015).
47. Liebisch, G., Binder, M., Schifferer, R., Langmann, T., Schulz, B. and Schmitz, G., “High throughput quantification of cholesterol and cholesteryl ester by electrospray ionization tandem mass spectrometry (ESI-MS/MS),” Biochim. Biophys. Acta 1761(1), 121-128 (2006).
48. Herzog, R., Schuhmann, K., Schwudke, D., Sampaio, J. L., Bornstein, S. R., Schroeder, M. and Shevchenko, A., “LipidXplorer: A Software for Consensual Cross-Platform Lipidomics,” PLOS ONE 7(1), e29851 (2012).
49. Reidy K, Kang HM, Hostetter T, Susztak K. (2014) Molecular mechanisms of diabetic kidney disease. J Clin Invest. 124(6):2333-40 (2014).

What is claimed is:

1. A method of spectral angle mapping, the method comprising quantifying the spectral similarity between an image pixel spectrum and a known reference spectrum.

2. The method of claim 1, wherein quantifying the spectral similarity between an image pixel spectrum and a known reference spectrum comprises:
preprocessing an image to determine the image pixel spectrum;
interpolating pixel intensities of the image pixel spectrum such that all the image pixel spectra have the same resolution;
determining a similarity score between the image pixel spectra and the reference spectra; and
proportionally reducing the similarity score with the positional discrepancy to the best spectral match.

3. The method of claim 2, wherein reducing the similarity score is effective to decrease the rate of false positive similarity scores.

4. The method of claim 1, wherein spectral angle mapping is effective to characterize lipid subtypes in human tissue.

5. The method of claim 4, wherein characterizing lipid subtypes in human tissue is effective for identifying tissue abnormalities.

6. The method of claim 1, wherein the spectral angle mapping is effective to detect small and large molecules, such as lipids, proteins, DNA, RNA, carbohydrates, sugars, ions, and/or mineral molecules.

7. The method of claim 1, wherein the spectral angle mapping is effective to qualify and/or verify a concentration of a chemical compound in a high throughput product.

8. The method of claim 1, wherein the spectral angle mapping is effective to classify a material defect.
